(19) United States
(12) Patent Application Publication
(10) Pub. No.: US 2026/0285155 A1
(43) Pub. Date: Sep. 24, 2026

(54) CONTENT CONTROL DEVICE, CONTENT CONTROL METHOD, AND STORAGE MEDIUM

(71) Applicant: HONDA MOTOR CO., LTD., Tokyo (JP)

(72) Inventor: Takashi Noguchi, Tokyo (JP)

(21) Appl. No.: 19/447,711

(22) Filed: Jan. 13, 2026

(30) Foreign Application Priority Data
Mar. 19, 2025 (JP) 2025-044664

(51) Int. Cl. B60K 35/29; B60K 35/10

(52) U.S. Cl. CPC B60K 35/29; B60K 35/10; B60K 2360/148; B60K 2360/741

(57) ABSTRACT

A content control device includes: a content output unit outputting a content to each seat; a voice detection unit detecting a speaking content of a passenger; a content control unit controlling the content output unit; and a passenger detection unit detecting a passenger seated on each seat, and when the speaking content involves an instruction passenger name indicating a target passenger to whom a change in the content is to be instructed, the content control unit determines a control target content, which is a content to be controlled based on the speaking content, based on the instruction passenger name, first passenger information detected by the passenger detection unit and indicating the passenger seated on the seat corresponding to each of the plurality of contents output by the content output unit, and account information corresponding to each of the plurality of contents output by the content output unit.

### INCORPORATION BY REFERENCE

The present application claims priority under 35 U.S.C. § 119 to Japanese Patent Application No. 2025-044664 filed on Mar. 19, 2025. The content of the application is incorporated herein by reference in its entirety.

### BACKGROUND OF THE INVENTION

### Field of the Invention

The present invention relates to a content control device, a content control method, and a storage medium.

### Description of the Related Art

Japanese Patent Laid-Open No. 2020-199974 discloses an output control device as follows. In other words, the output control device includes an output control unit, a reception unit, and a designation unit. The output control unit outputs contents to each of a plurality of seating positions. The reception unit receives a voice input including a prescribed instruction word from a passenger at the seating position. The designation unit designates one seating position from the plurality of seating positions based on the instruction word included in the voice input received by the reception unit and the seating position of the passenger who inputs the voice. The output control unit outputs the content output to the seating position designated by the designation unit to other seating positions.

However, it is assumed in the invention disclosed in Japanese Patent Laid-Open No. 2020-199974 that the instruction word included in the voice input is used a passenger name to control the content, but it may not be easy to control the content using the passenger name. For example, it may not be easy to determine a seat in which the passenger corresponding to the passenger name is seated.

In other words, there is a problem of determining appropriately the content to be controlled.

The present invention aims to improve the operability of a vehicle in order to solve the above problems. Thereby, the present invention aims to further improve traffic safety and contribute the development of a sustainable transportation system.

### SUMMARY OF THE INVENTION

In order to achieve the above object, a first aspect of the present invention provides a content control device including: a content output unit that outputs a content to each of a plurality of seats arranged in a vehicle; a voice detection unit that detects a speaking content of a passenger in the vehicle; a content control unit that controls the content output unit based on the speaking content detected by the voice detection unit; and a passenger detection unit that detects a passenger seated on each of the plurality of seats, in which, when the speaking content involves an instruction passenger name indicating a target passenger to whom a change in the content is to be instructed, the content control unit determines a control target content, which is a content to be controlled based on the speaking content, based on the instruction passenger name, first passenger information detected by the passenger detection unit and indicating the passenger seated on the seat corresponding to each of the plurality of contents output by the content output unit, and account information corresponding to each of the plurality of contents output by the content output unit.

In order to achieve the above object, a second aspect of the present invention provides a content control method performed by a content control device, the content control device including: a content output unit that outputs a content to each of a plurality of seats arranged in a vehicle; a voice detection unit that detects a speaking content of a passenger in the vehicle; a content control unit that controls the content output unit based on the speaking content detected by the voice detection unit; and a passenger detection unit that detects a passenger seated on each of the plurality of seats, in which, when the speaking content involves an instruction passenger name indicating a passenger seated on a seat to whom a change in the content is to be instructed, the content control unit executes a determining step of determining a control target content, which is a content to be controlled based on the speaking content, based on the instruction passenger name, first passenger information detected by the passenger detection unit and indicating the passenger seated on the seat corresponding to each of the plurality of contents output by the content output unit, and account information corresponding to each of the plurality of contents output by the content output unit.

In order to achieve the above object, a third aspect of the present invention provides a non-transitory computer readable storage medium storing a content control program that causes a processor included in a content control device to function as: a content output unit that outputs a content to each of a plurality of seats arranged in a vehicle; a voice detection unit that detects a speaking content of a passenger in the vehicle; a content control unit that controls the content output unit based on the speaking content detected by the voice detection unit; and a passenger detection unit that detects a passenger seated on each of the plurality of seats, in which, when the speaking content involves an instruction passenger name indicating a passenger seated on a seat to whom a change in the content is to be instructed, the content control unit determines a control target content, which is a content to be controlled based on the speaking content, based on the instruction passenger name, first passenger information detected by the passenger detection unit and indicating the passenger seated on the seat corresponding to each of the plurality of contents output by the content output unit, and account information corresponding to each of the plurality of contents output by the content output unit.

According to the content control device, the content control method, and the storage medium, it is possible to appropriately determine the content to be controlled.

### BRIEF DESCRIPTION OF THE DRAWINGS

FIG. 1 is a plan view illustrating an example of a configuration of a vehicle mounted with a content control device;

FIG. 2 is a diagram illustrating an example of a configuration of the content control device;

FIG. 3 is a table illustrating an example of a first table and a second table stored by an association storage unit;

FIG. 4 is a table illustrating an example of first passenger information and second passenger information;

FIG. 5 is a table illustrating another example of first passenger information and second passenger information;

FIG. 6 is a table illustrating further another example of first passenger information and second passenger information, and control contents of a content control unit;

FIG. 7 is a flowchart illustrating an example of processing of the content control device; and

FIG. 8 is a flowchart illustrating an example of control target content determination processing of the content control device.

### DETAILED DESCRIPTION OF THE PREFERRED EMBODIMENT

Hereinafter, embodiments of a content control device, a content control method, and a content control program will be described with reference to the drawings.

### [1. Configuration of Vehicle]

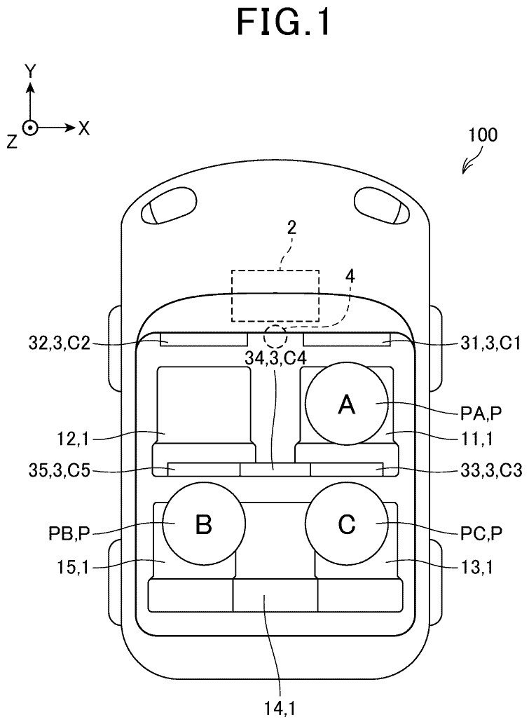

First, a configuration of a vehicle 100 mounted with a content control device 2 will be described with reference to FIG. 1. FIG. 1 is a plan view illustrating an example of the vehicle 100 mounted with the content control device 2.

FIG. 1 illustrates an X-axis, a Y-axis, and a Z-axis that are orthogonal to each other. The X-axis and the Y-axis are parallel to a horizontal direction. The Z-axis is parallel to a vertical direction. The X-axis is parallel to a left-right direction of the vehicle 100. The Y-axis is parallel to a front-rear direction of the vehicle 100. A positive direction of the X-axis indicates a right direction of the vehicle. A positive direction of the Y-axis indicates a front direction of the vehicle. A positive direction of the Z-axis indicates an upward direction of the vehicle.

FIG. 1 illustrates a plan view of the vehicle 100 being in a state where a roof is removed.

As illustrated in FIG. 1, the vehicle 100 includes a seat 1, a content control device 2, an input/output mechanism 3, and a camera 4.

The seat 1 is constituted by a first seat 11, a second seat 12, a third seat 13, a fourth seat 14, and a fifth seat 15.

The first seat 11 and the second seat 12 are arranged at a front part in the vehicle 100. The first seat 11 and the second seat 12 constitute front seats. The third seat 13, the fourth seat 14, and the fifth seat 15 are arranged behind the first seat 11 and the second seat 12 in the vehicle 100. The third seat 13, the fourth seat 14, and the fifth seat 15 constitute back seats.

The first seat 11 is a driver's seat arranged on a right side in the front seats. A passenger PA is seated on the first seat 11. The passenger PA is a driver. In the present embodiment, the driver is included in the passenger P.

The second seat 12 is a passenger seat arranged to a left of the first seat 11. In the present embodiment, the passenger P is not seated on the second seat 12.

The third seat 13 is a seat arranged on the right side in the back seats. In the present embodiment, a passenger PC is seated on the third seat 13.

The fourth seat 14 is a seat arranged in a center part in the back seats. In the present embodiment, the passenger P is not seated on the fourth seat 14.

The fifth seat 15 is a seat arranged on the left side in the back seats. In the present embodiment, a passenger PB is seated on the fifth seat 15.

In the following description, the first seat 11, the second seat 12, the third seat 13, the fourth seat 14, and the fifth seat 15 may be referred to as a seat 1 unless otherwise distinguished from one another.

The input/output mechanism 3 is constituted by a first input/output mechanism 31, a second input/output mechanism 32, a third input/output mechanism 33, a fourth input/output mechanism 34, and a fifth input/output mechanism 35.

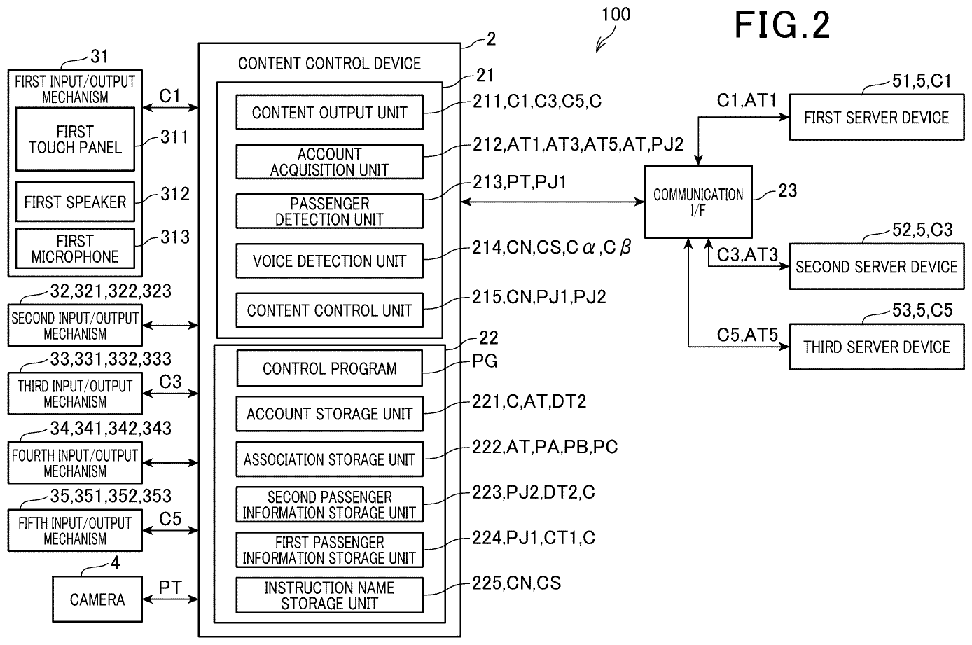

As described with reference to FIG. 2, the first input/output mechanism 31 includes a first touch panel 311, a first speaker 312, and a first microphone 313. The second input/output mechanism 32 includes a second touch panel 321, a second speaker 322, and a second microphone 323. The third input/output mechanism 33 includes a third touch panel 331, a third speaker 332, and a third microphone 333. The fourth input/output mechanism 34 includes a fourth touch panel 341, a fourth speaker 342, and a fourth microphone 343. The fifth input/output mechanism 35 includes a fifth touch panel 351, a fifth speaker 352, and a fifth microphone 353.

The first input/output mechanism 31 is arranged on a dashboard in front of the first seat 11, for example. The first touch panel 311 of the first input/output mechanism 31 is arranged such that a display screen thereof faces the passenger PA. In other words, the first touch panel 311 of the first input/output mechanism 31 is arranged such that the display screen faces rearward.

The first touch panel 311 and the first speaker 312 output a content C according to instructions from the content control device 2. In the present embodiment, the first touch panel 311 and the first speaker 312 output a content C1. The first touch panel 311 displays an image in the content C1. The first speaker 312 outputs voice in the content C1.

In the present embodiment, since the passenger PA is the driver, the first touch panel 311 is prohibited from displaying images when the passenger PA is driving.

Voice spoken by the passenger PA is input to the first microphone 313. The first microphone 313 outputs a voice signal corresponding to the input voice to the content control device 2.

The second input/output mechanism 32 is arranged on a dashboard in front of the second seat 12, for example. The second touch panel 321 of the second input/output mechanism 32 is arranged such that a display screen thereof faces the passenger P seated on the second seat 12. In other words, the second touch panel 321 of the second input/output mechanism 32 is arranged such that the display screen faces rearward.

The second touch panel 321 and the second speaker 322 output a content C according to instructions from the content control device 2. The second touch panel 321 displays an image in the content C. The second speaker 322 outputs voice in the content C. In the present embodiment, since the passenger P is not seated on the second seat 12, the second touch panel 321 and the second speaker 322 do not output the content C.

The voice spoken from the passenger P seated on the second seat 12 is input to a second microphone 323. The second microphone 323 outputs a voice signal corresponding to the input voice to the content control device 2. In the present embodiment, since the passenger P is not seated on the second seat 12, the voice is not input to the second microphone 323.

The third input/output mechanism 33 is arranged, for example, on a back surface of the first seat 11 in front of the third seat 13, that is, on the back surface of the backrest of the first seat 11. The third touch panel 331 of the third input/output mechanism 33 is arranged such that a display screen thereof faces the passenger PC. In other words, the third touch panel 331 of the third input/output mechanism 33 is arranged such that the display screen faces rearward.

The third touch panel 331 and the third speaker 332 output a content C according to instructions from the content control device 2. In the present embodiment, the third touch panel 331 and the third speaker 332 output a content C3. The third touch panel 331 displays an image in the content C3. The third speaker 332 outputs voice in the content C3.

The voice spoken from the passenger PA is input to a third microphone 333. The third microphone 333 outputs a voice signal corresponding to the input voice to the content control device 2.

The fourth input/output mechanism 34 is arranged, for example, on a back surface of the first seat 11 and the second seat 12 in front of the fourth seat 14. The fourth touch panel 341 of the fourth input/output mechanism 34 is arranged such that a display screen thereof faces the passenger P seated on the fourth seat 14. In other words, the fourth touch panel 341 of the fourth input/output mechanism 34 is arranged such that the display screen faces rearward.

The fourth touch panel 341 and the fourth speaker 342 output a content C according to instructions from the content control device 2. The fourth touch panel 341 displays an image in the content C. The fourth speaker 342 outputs voice in the content C. In the present embodiment, since the passenger P is not seated on the fourth seat 14, the fourth touch panel 341 and the fourth speaker 342 do not output the content C.

The voice spoken from the passenger P seated on the fourth seat 14 is input to a fourth microphone 343. The fourth microphone 343 outputs a voice signal corresponding to the input voice to the content control device 2. In the present embodiment, since the passenger P is not seated on the fourth seat 14, the voice is not input to the fourth microphone 343.

The fifth input/output mechanism 35 is arranged, for example, on a back surface of the second seat 12 in front of the fifth seat 15. The fifth touch panel 351 of the fifth input/output mechanism 35 is arranged such that a display screen thereof faces the passenger PB. In other words, the fifth touch panel 351 of the fifth input/output mechanism 35 is arranged such that the display screen faces rearward.

The fifth touch panel 351 and the fifth speaker 352 output a content C according to instructions from the content control device 2. In the present embodiment, the fifth touch panel 351 and the fifth speaker 352 output a content C5. The fifth touch panel 351 displays an image in the content C5. The fifth speaker 352 outputs voice in the content C5.

The voice spoken from the passenger PB is input to a fifth microphone 353. The fifth microphone 353 outputs a voice signal corresponding to the input voice to the content control device 2.

The content control device 2 acquires the content C from a server device 5 (computer) illustrated in FIG. 2, and outputs the content C to the input/output mechanism 3.

In the present embodiment, the content control device 2 acquires the content C1 from a first server device 51 illustrated in FIG. 2, and outputs the content C1 to the first touch panel 311 and the first speaker 312 of the first input/output mechanism 31. The content control device 2 acquires the content C3 from a second server device 52 illustrated in FIG. 2, and outputs the content C3 to the third touch panel 331 and the third speaker 332 of the third input/output mechanism 33. The content control device 2 acquires the content C5 from a third server device 53 illustrated in FIG. 2, and outputs the content C5 to the fifth touch panel 351 and the fifth speaker 352 of the fifth input/output mechanism 35.

A voice signal corresponding to voice spoken by the passenger P is input to the content control device 2 from the input/output mechanism 3.

In the present embodiment, since the passenger PA is seated on the first seat 11, a voice signal corresponding to voice spoken by the passenger PA is input to the content control device 2 from the first microphone 313 of the first input/output mechanism 31. In addition, since the passenger PC is seated on the third seat 13, a voice signal corresponding to voice spoken by the passenger PC is input to the content control device 2 from the third microphone 333 of the third input/output mechanism 33. Since the passenger PB is seated on the fifth seat 15, a voice signal corresponding to voice spoken by the passenger PB is input to the content control device 2 from the fifth microphone 353 of the fifth input/output mechanism 35.

A configuration of the content control device 2 will be further described with reference to FIG. 2.

In the following description, the passenger PA, the passenger PB, and the passenger PC may be referred to as the passenger P unless otherwise distinguished from one another.

The camera 4 is arranged on, for example, an interior side of the roof (not illustrated), that is, in front of a lower surface. The camera 4 generates an image PT including all of the passengers P, who get in the vehicle 100, according to instructions from the content control device 2. The camera 4 outputs the generated image PT to the content control device 2.

In the present embodiment, the camera 4 generates an image PT including the passenger PA seated on the first seat 11, the passengers PC seated on the third seat 13, and the passengers PB seated on the fifth seat 15, according to instructions from the content control device 2.

In the present embodiment, a case will be described in which the passengers P are three people, that is, the passenger PA, the passenger PB, and the passenger PC, but the embodiment is not limited thereto. The passengers P may be many. For example, the passengers P may be two people. Furthermore, the passengers P may be four or more people.

For convenience, the description has been given with respect to the case in which the passenger PA is seated on the first seat 11, the passenger PB is seated on the third seat 13, and the passenger PC is seated on the fifth seat 15, with reference to FIG. 1.

However, since the passenger P may change his/her posture and the passenger P may move from the seat 1 on which he/she is seated, the content control device 2 cannot easily detect the passengers P seated on the first seat 11, the third seat 13, and the fifth seat 15.

Therefore, in the following description, a case will be described in which the content control device 2 has not identified the passengers P seated on the first seat 11, the third seat 13, and the fifth seat 15 in an initial state.

### [2. Configuration of Content Control Device]

Next, the configuration of the content control device 2 will be described with reference to FIG. 2. FIG. 2 is a diagram illustrating an example of the configuration of the content control device 2.

As illustrated in FIG. 2, the content control device 2 is communicably connected to the first input/output mechanism 31, the second input/output mechanism 32, the third input/output mechanism 33, the fourth input/output mechanism 34, the fifth input/output mechanism 35, and the camera 4.

The first input/output mechanism 31 includes the first touch panel 311, the first speaker 312, and the first microphone 313.

The first touch panel 311 includes a display such as a liquid crystal display (LCD) and a touch sensor. The display displays various images according to instructions from the content control device 2. The touch sensor is formed integrally with the display screen of the display, and detects a touch operation of the passenger P. The touch sensor outputs a signal indicating the detected touch operation to the content control device 2.

The first speaker 312 outputs various types of voice according to instructions from the content control device 2.

The voice spoken by the passenger P is input to the first microphone 313. The first microphone 313 outputs a voice signal corresponding to the input voice to the content control device 2.

The second input/output mechanism 32 includes a second touch panel 321, a second speaker 322, and a second microphone 323. The third input/output mechanism 33 includes a third touch panel 331, a third speaker 332, and a third microphone 333. The fourth input/output mechanism 34 includes a fourth touch panel 341, a fourth speaker 342, and a fourth microphone 343. The fifth input/output mechanism 35 includes a fifth touch panel 351, a fifth speaker 352, and a fifth microphone 353.

Each of the second touch panel 321, the third touch panel 331, the fourth touch panel 341, and the fifth touch panel 351 has substantially the same configuration as the first touch panel 311.

In the following description, the first touch panel 311, the second touch panel 321, the third touch panel 331, the fourth touch panel 341, and the fifth touch panel 351 may be referred to as a “touch panel TP” unless otherwise distinguished from one another.

Each of the second speaker 322, the third speaker 332, the fourth speaker 342, and the fifth speaker 352 has substantially the same configuration as the first speaker 312.

In the following description, the first speaker 312, the second speaker 322, the third speaker 332, the fourth speaker 342, and the fifth speaker 352 may be referred to as a “speaker SP” unless otherwise distinguished from one another.

Each of the second microphone 323, the third microphone 333, the fourth microphone 343, and the fifth microphone 353 has substantially the same configuration as the first microphone 313.

In the following description, the first microphone 313, the second microphone 323, the third microphone 333, the fourth microphone 343, and the fifth microphone 353 may be referred to as a “microphone MC” unless otherwise distinguished from one another.

Voice spoken by the passenger P seated on the third seat 13 is input to the third microphone 333. Voice spoken by the passenger P seated on the fifth seat 15 is input to the fifth microphone 353.

The camera 4 includes an image sensor such as a charge coupled device (CCD), and generates an image PT including all of the passengers P, who get in the vehicle 100, according to instructions from the content control device 2. The camera 4 outputs the generated image PT to the content control device 2.

The content control device 2 is constituted by an electronic control unit (ECU), for example. The content control device 2 includes a processor 21, a memory 22, and a communication interface 23.

The communication interface 23 includes an antenna, a connector, and an interface circuit, and is connected to the processor 21. The communication interface 23 is an interface for communicating with the server device 5. The communication interface 23 is an interface for wirelessly communicating with the server device 5 according to the 4G standard, the 5G standard, or the Wi-Fi (registered trademark) standard.

The communication interface 23 wirelessly communicates with the server device 5 via wireless base station (not illustrated) and the Internet.

The server device 5 includes, for example, the first server device 51, the second server device 52, and the third server device 53.

The first server device 51 transmits the content C1 to the content control device 2 in response to a request from the content control device 2. The second server device 52 transmits the content C3 to the content control device 2 in response to a request from the content control device 2. The third server device 53 transmits the content C5 to the content control device 2 in response to a request from the content control device 2.

Each of the content C1, the content C3, and the content C5 is an example of the content C.

The content C includes, for example, image information and voice information.

In the present embodiment, a case will be described in which the content C includes image information and voice information, but the embodiment is not limited thereto. The content C may include voice information but not image information, for example.

In the following description, the content C1, the content C3, and the content C5 may be referred to as content C unless otherwise distinguished from one another.

The processor 21 is constituted by a central processing unit (CPU) or a micro processing unit (MPU). The processor 21 may be constituted by a single processor or a plurality of processors. The memory 22 is constituted by, for example, a non-volatile semiconductor memory, or a combination of a volatile semiconductor memory and a non-volatile semiconductor memory. The memory 22 stores a control program PG.

The control program PG corresponds to an example of a “content control program”.

The content control device 2 includes a content output unit 211, an account acquisition unit 212, a passenger detection unit 213, a voice detection unit 214, a content control unit 215, an account storage unit 221, an association storage unit 222, a second passenger information storage unit 223, a first passenger information storage unit 224, and an instruction name storage unit 225.

The processor 21 executes the control program PG stored in the memory 22 to function as the content output unit 211, the account acquisition unit 212, the passenger detection unit 213, the voice detection unit 214, and the content control unit 215. In addition, the processor 21 executes the control program PG stored in the memory 22 to cause the memory 22 to function as the account storage unit 221, the association storage unit 222, the second passenger information storage unit 223, the first passenger information storage unit 224, and the instruction name storage unit 225.

The account storage unit 221 stores account information AT corresponding to the content C.

The account storage unit 221 stores, for example, account information AT1 corresponding to the content C1. The account information AT1 is account information AT logged in to the first server device 51 such that the content output unit 211 downloads the content C1 from the first server device 51. Furthermore, the account information AT1 is associated with second date-and-time information DT2 indicating the date and time of login to the first server device 51 and with the content C1, and is stored in the account storage unit 221 by the account acquisition unit 212. The second date-and-time information DT2 indicates date and time when the account information AT1 is acquired by the account acquisition unit 212.

For example, when the content output unit 211 downloads the content C1 from the first server device 51 without logging in to the first server device 51, the account information AT1 is not acquired by the account acquisition unit 212.

The account storage unit 221 stores, for example, account information AT3 corresponding to the content C3. The account information AT3 is account information AT logged in to the second server device 52 such that the content output unit 211 downloads the content C3 from the second server device 52. Furthermore, the account information AT3 is associated with second date-and-time information DT2 indicating the date and time of login to the second server device 52 and with the content C3, and is stored in the account storage unit 221 by the account acquisition unit 212. The second date-and-time information DT2 indicates date and time when the account information AT3 is acquired by the account acquisition unit 212.

For example, when the content output unit 211 downloads the content C3 from the second server device 52 without logging in to the second server device 52, the account information AT3 is not acquired by the account acquisition unit 212.

The account storage unit 221 stores, for example, account information AT5 corresponding to the content C5. The account information AT5 is account information AT logged in to the third server device 53 such that the content output unit 211 downloads the content C5 from the third server device 53. Furthermore, the account information AT5 is associated with second date-and-time information DT2 indicating the date and time of login to the third server device 53 and with the content C5, and is stored in the account storage unit 221 by the account acquisition unit 212. The second date-and-time information DT2 indicates date and time when the account information AT5 is acquired by the account acquisition unit 212.

For example, when the content output unit 211 downloads the content C5 from the third server device 53 without logging in to the third server device 53, the account information AT5 is not acquired by the account acquisition unit 212.

In the following description, the account information AT1, the account information AT3, and the account information AT5 may be referred to as account information AT unless otherwise distinguished from one another.

The association storage unit 222 stores in advance second passenger information PJ2 indicating the passenger P corresponding to the account information AT. The passenger P includes, for example, the passenger PA, the passenger PB, and the passenger PC. The account information AT includes, for example, the account information AT1, the account information AT3, and the account information AT5. The account information AT1 corresponds to the content C1. The account information AT3 corresponds to the content C3. The account information AT5 corresponds to the content C5.

Each of the account information AT1, the account information AT3, and the account information AT5 is, for example, the account information AT regarding the passenger PA, the passenger PB, or the passenger PC.

The association storage unit 222 stores, as a first table TBL1, in advance the account information AT and the second passenger information PJ2 indicating the passenger P corresponding to the account information AT in association with each other. The account information AT includes the account information AT1, the account information AT3, and the account information AT5.

In addition, the association storage unit 222 stores, as a second table TBL2, in advance an instruction passenger name CN and passenger information PJ indicating the passenger corresponding to the instruction passenger name CN in association with each other. The instruction passenger name CN is detected by the voice detection unit 214. The passenger information PJ includes passenger information indicating each of the plurality of passengers P. In other words, the passenger information PJ includes the passenger information corresponding to the passenger PA, the passenger information corresponding to the passenger PB, and the passenger information corresponding to the passenger PC.

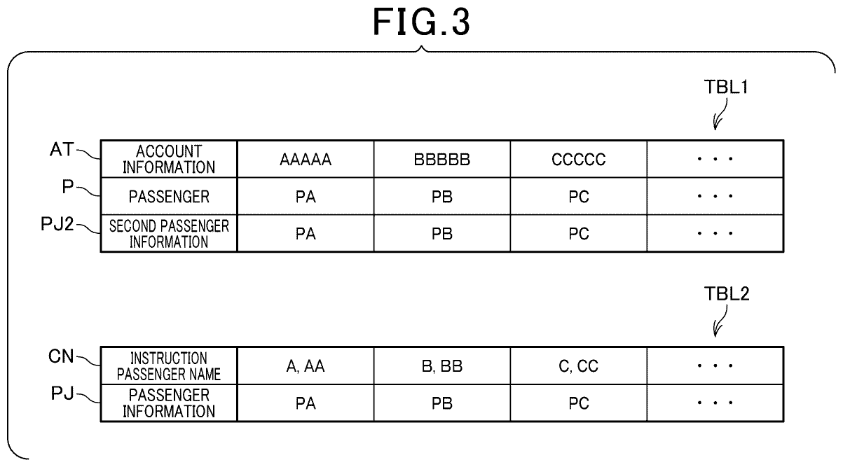

Here, a description will be described with reference to FIG. 3 with respect to an example of the first table TBL1 and the second table TBL2 stored by the association storage unit 222. FIG. 3 is a table illustrating an example of the first table TBL1 and the second table TBL2 stored by the association storage unit 222.

As illustrated in FIG. 3, the first table TBL1 associates the account information AT, the passenger P corresponding to the account information AT, and the second passenger information PJ2 indicating the passenger P corresponding to the account information AT with each other.

As illustrated in the first table TBL1, when the account information AT is, for example, “AAAAA”, the passenger P corresponding to the account information AT is a passenger PA, and the second passenger information PJ2 indicating the passenger PA corresponding to the account information AT is, for example, “PA”.

When the account information AT is, for example, “BBBBB”, the passenger P corresponding to the account information AT is a passenger PB, and the second passenger information PJ2 indicating the passenger PB corresponding to the account information AT is, for example, “PB”.

When the account information AT is, for example, “CCCCC”, the passenger P corresponding to the account information AT is a passenger PC, and the second passenger information PJ2 indicating the passenger PC corresponding to the account information AT is, for example, “PC”.

As illustrated in FIG. 3, the second table TBL2 associates the instruction passenger name CN with the passenger information PJ indicating the passenger corresponding to the instruction passenger name CN.

As illustrated in the second table TBL2, when the instruction passenger name CN is, for example, “A” or “AA”, the passenger P corresponding to the instruction passenger name CN is a passenger PA, and the passenger information PJ indicating the passenger PA corresponding to the instruction passenger name CN is, for example, “PA”. “A” is, for example, the abbreviation of the passenger PA, and “AA” is, for example, a “last name” or “first name” of the passenger PA.

When the instruction passenger name CN is, for example, “B” or “BB”, the passenger P corresponding to the instruction passenger name CN is a passenger PB, and the passenger information PJ indicating the passenger PB corresponding to the instruction passenger name CN is, for example, “PB”. “B” is, for example, the abbreviation of the passenger PB, and “BB” is, for example, a “last name” or “first name” of the passenger PB.

When the instruction passenger name CN is, for example, “C” or “CC”, the passenger P corresponding to the instruction passenger name CN is a passenger PC, and the passenger information PJ indicating the passenger PC corresponding to the instruction passenger name CN is, for example, “PC”. “C” is, for example, the abbreviation of the passenger PC, and “CC” is, for example, a “last name” or “first name” of the passenger PC.

Returning to FIG. 2 again, the configuration of the content control device 2 will be further described.

The second passenger information storage unit 223 stores a plurality of contents C and second passenger information PJ2 corresponding to each of the plurality of contents C in association with each other.

The plurality of contents C are a plurality of contents C output by the content output unit 211. The second passenger information PJ2 indicates the passenger P corresponding to the account information AT of each of the plurality of contents C output by the content output unit 211.

The plurality of contents C and the second passenger information PJ2 corresponding to each of the plurality of contents C are stored in association with each other in the second passenger information storage unit 223 by the account acquisition unit 212. When acquiring the account information AT, the account acquisition unit 212 refers to the association storage unit 222, reads out the second passenger information PJ2 indicating the passenger P corresponding to the account information AT, and allows the second passenger information storage unit 223 to store the second passenger information PJ2 in association with the content C.

The first passenger information storage unit 224 stores the plurality of contents C and first passenger information PJ1 corresponding to each of the plurality of contents C in association with each other. The plurality of contents C are the plurality of contents C output by the content output unit 211. The first passenger information PJ1 is detected by the passenger detection unit 213, and indicates the passenger P seated on the seat 1 corresponding to each of the plurality of contents C output by the content output unit 211.

The plurality of contents C are, for example, contents C1, C3, and C5. The content C1 is output, for example, from the first input/output mechanism 31 to the passenger P on the first seat 11. The content C3 is output, for example, from the third input/output mechanism 33 to the passenger P on the third seat 13. The content C5 is output, for example, from the fifth input/output mechanism 35 to the passenger P on the fifth seat 15.

The plurality of contents C, the first passenger information PJ1 corresponding to each of the plurality of contents C, and first date-and-time information DT1 are stored in the first passenger information storage unit 224 by the passenger detection unit 213. The first date-and-time information DT1 indicates the date and time when the first passenger information PJ1 is detected by the passenger detection unit 213.

For example, the first passenger information PJ1 corresponding to the content C1 indicates, out of the passengers P detected by the passenger detection unit 213, the passenger P seated on the first seat 11. For example, the first passenger information PJ1 corresponding to the content C3 indicates, out of the passengers P detected by the passenger detection unit 213, the passenger P seated on the third seat 13. For example, the first passenger information PJ1 corresponding to the content C5 indicates, out of the passengers P detected by the passenger detection unit 213, the passenger P seated on the fifth seat 15.

The instruction name storage unit 225 stores the instruction passenger name CN. The instruction passenger name CN is stored in the instruction name storage unit 225 by the voice detection unit 214. The instruction passenger name CN indicates the target passenger P to whom a change in content C is to be instructed.

When the speaking content of the passenger P detected by the voice detection unit 214 involves the instruction passenger name CN indicating the target passenger P to whom a change in the content C is to be instructed, the voice detection unit 214 allows the instruction name storage unit 225 to store the instruction passenger name CN.

In addition, the instruction name storage unit 225 stores an instruction content name CS indicating a content Cβ after the change.

When the speaking content of the passenger P detected by the voice detection unit 214 involves the instruction passenger name CN indicating the target passenger P to whom a change in the content C is to be instructed, the voice detection unit 214 allows the instruction name storage unit 225 to store the instruction passenger name CN and the instruction content name CS indicating the content Cβ after the change.

The content output unit 211 receives instructions including the account information AT from the passenger P via the touch panel TP, downloads the content C from the server device 5 based on the instructions from the passenger P, and outputs the content C from the touch panel TP and the speaker SP.

Next, an example of processing of the content output unit 211 will be described.

First, the content output unit 211 displays a plurality of icons on the touch panel TP, for example. The icons correspond to websites that provide the contents. The websites correspond to the server devices 5 that provide the contents.

For example, the passenger P performs a touch operation to select one icon from the plurality of icons displayed on the touch panel TP.

The content output unit 211 is communicably connected to the server device 5 corresponding to the selected one icon.

Next, the passenger P inputs the account information AT via the touch panel TP. The content output unit 211 transmits the account information AT to the server device 5, which is communicably connected, and logs in to the server device 5. The content output unit 211 may transmit password information in addition to the account information AT.

Next, the content output unit 211 displays icons corresponding to the plurality of contents C, which are provided by the server device 5, on the touch panel TP.

The passenger P performs a touch operation to select an icon corresponding to one content C, which is wished to view, from the plurality of contents C provided by the server device 5. The content output unit 211 downloads the selected one content C from the server device 5, and outputs it from the touch panel TP and the speaker SP.

The content output unit 211 receives instructions including the account information AT1 from the passenger P seated on the first seat 11, for example, via the first touch panel 311, downloads the content C1 from the first server device 51 based on the instructions from the passenger P, and outputs the content C1 from the first touch panel 311 and the first speaker 312.

The content output unit 211 receives instructions including the account information AT3 from the passenger P seated on the third seat 13, for example, via the third touch panel 331, downloads the content C3 from the second server device 52 based on the instructions from the passenger P, and outputs the content C3 from the third touch panel 331 and the third speaker 332.

In addition, the content output unit 211 receives instructions including the account information AT5 from the passenger P seated on the fifth seat 15, for example, via the fifth touch panel 351, downloads the content C5 from the third server device 53 based on the instructions from the passenger P, and outputs the content C5 from the fifth touch panel 351 and the fifth speaker 352.

The account acquisition unit 212 acquires the account information AT corresponding to the content C and the second date-and-time information DT2, and allows the account storage unit 221 to store the account information AT and the second date-and-time information DT2 in association with the content C.

For example, when the content output unit 211 downloads the content C1 from the first server device 51, the account acquisition unit 212 acquires the account information AT1 logged in to the first server device 51. The account acquisition unit 212 acquires the second date-and-time information DT2 indicating the date and time of login to the first server device 51.

Furthermore, the account acquisition unit 212 allows the account storage unit 221 to store, for example, the account information AT1 and the second date-and-time information DT2 in association with the content C1.

In addition, when acquiring the account information AT1, for example, the account acquisition unit 212 refers to the association storage unit 222 described with reference to FIG. 3, reads out the second passenger information PJ2 indicating the passenger P corresponding to the account information AT1, and allows the second passenger information storage unit 223 to store the second passenger information PJ2 in association with the content C1.

For example, when the content output unit 211 downloads the content C3 from the second server device 52, the account acquisition unit 212 acquires the account information AT3 logged in to the second server device 52. The account acquisition unit 212 acquires the second date-and-time information DT2 indicating the date and time of login to the second server device 52.

Furthermore, the account acquisition unit 212 allows the account storage unit 221 to store, for example, the account information AT3 and the second date-and-time information DT2 in association with the content C3.

In addition, when acquiring the account information AT3, for example, the account acquisition unit 212 refers to the association storage unit 222 described with reference to FIG. 3, reads out the second passenger information PJ2 indicating the passenger P corresponding to the account information AT3, and allows the second passenger information storage unit 223 to store the second passenger information PJ2 in association with the content C3.

For example, when the content output unit 211 downloads the content C5 from the third server device 53, the account acquisition unit 212 acquires the account information AT5 logged in to the third server device 53. The account acquisition unit 212 acquires the second date-and-time information DT2 indicating the date and time of login to the third server device 53.

Furthermore, the account acquisition unit 212 allows the account storage unit 221 to store, for example, the account information AT5 and the second date-and-time information DT2 in association with the content C5.

In addition, when acquiring the account information AT5, for example, the account acquisition unit 212 refers to the association storage unit 222 described with reference to FIG. 3, reads out the second passenger information PJ2 indicating the passenger P corresponding to the account information AT5, and allows the second passenger information storage unit 223 to store the second passenger information PJ2 in association with the content C5.

In the present embodiment, a case will be described in which the account acquisition unit 212 reads out the second passenger information PJ2 indicating the passenger P corresponding to the account information AT and stores the second passenger information PJ2 in the second passenger information storage unit 223 in association with the content C, but the embodiment is not limited thereto. The account acquisition unit 212 may store the account information AT in the memory 22 in association with the content C.

In this case, the content control unit 215 determines whether the account information AT instead of the second passenger information PJ2 matches the passenger information PJ indicated by the instruction passenger name CN. The content control unit 215 determines the second passenger information PJ2 corresponding to the account information AT, for example, referring to the first table TBL1 illustrated in FIG. 3, and determines whether the second passenger information PJ2 corresponding to the account information AT matches the passenger information PJ indicated by the instruction passenger name CN.

The passenger detection unit 213 detects the passenger P seated on each of the plurality of seats 1. The passenger detection unit 213 acquires the image PT from the camera 4, and performs, for example, image recognition processing on the image PT to detect the passenger P seated on each of the plurality of seats 1.

The passenger detection unit 213 performs, for example, image recognition processing on the image PT to detect the passenger P seated on the seat 1 corresponding to each of the plurality of contents C output by the content output unit 211.

The plurality of contents C are, for example, contents C1, C3, and C5. As described with reference to FIG. 1, the content C1 corresponds to the first seat 11. In other words, the content C1 is output from the first touch panel 311 and the first speaker 312 of the first input/output mechanism 31. The content C3 corresponds to the seat 13. In other words, the content C3 is output from the third touch panel 331 and the third speaker 332 of the third input/output mechanism 33. The content C5 corresponds to the seat 15. In other words, the content C5 is output from the fifth touch panel 351 and the fifth speaker 352 of the fifth input/output mechanism 35.

The passenger detection unit 213 detects, based on the image PT, the passenger P seated on the first seat 11 corresponding to the content C1, the passenger P seated on the third seat 13 corresponding to the content C3, and the passenger P seated on the fifth seat 15 corresponding to the content C5.

The passenger detection unit 213 allows the first passenger information storage unit 224 to store the first passenger information PJ1 indicating the detection result of the passenger P seated on the first seat 11 and the first date-and-time information DT1 in association with the content C1. The first date-and-time information DT1 indicates the date and time when the passenger detection unit 213 detects the first passenger information PJ1.

The passenger detection unit 213 allows the first passenger information storage unit 224 to store the first passenger information PJ1 indicating the detection result of the passenger P seated on the third seat 13 and the first date-and-time information DT1 in association with the content C3. In addition, the passenger detection unit 213 allows the first passenger information storage unit 224 to store the first passenger information PJ1 indicating the detection result of the passenger P seated on the fifth seat 15 and the first date-and-time information DT1 in association with the content C5.

The voice detection unit 214 acquires, from the speaker SP, voice spoken by the passenger P in the vehicle 100, and performs, for example, voice recognition processing on the acquired voice to detect the speaking content of the passenger P in the vehicle 100. Furthermore, the voice detection unit 214 determines whether the speaking content of the passenger P involves the instruction passenger name CN. The instruction passenger name CN is a name of the passenger P indicating the target passenger P to whom a change in the content C is to be instructed.

For example, when the instruction passenger name CN is “α”, the speaking content of the passenger P is “Please change Mr./Ms. α's content to content Cβ”.

In this case, the content control unit 215 changes the content C to be output to the passenger P indicated by “α”, which is the instruction passenger name CN, to “content Cβ”. In other words, the content control unit 215 causes the content output unit 211 to change the content C to be output to the passenger P indicated by “α”, which is the instruction passenger name CN, to “content Cβ”. The “α”, which is the instruction passenger name CN, indicates, for example, the passenger PA, the passenger PB, or the passenger PC.

When the speaking content of the passenger P involves the instruction passenger name CN, the voice detection unit 214 allows the instruction name storage unit 225 to store the instruction passenger name CN and the instruction content name CS indicating the content Cβ after the change.

### [3. Configuration of Content Control Unit]

The content control unit 215 determines, based on the instruction passenger name CN, the first passenger information PJ1, and the account information AT, a control target content Cα which is the content C to be controlled based on the speaking content detected by the voice detection unit 214.

The content control unit 215 determines, based on the instruction passenger name CN, the first passenger information PJ1, and the second passenger information PJ2, a control target content Cα which is the content C to be controlled based on the speaking content detected by the voice detection unit 214. The second passenger information PJ2 indicates the passenger P corresponding to the account information AT.

The content control unit 215 refers to the second table TBL2 described with reference to FIG. 3 to determine the passenger information PJ indicating the passenger P corresponding to the instruction passenger name CN.

In the following description, a case will be described in which the instruction passenger name CN is a passenger name of the passenger PA.

The content control unit 215 determines the content C corresponding to the passenger PA as the control target content Cα, based on the instruction passenger name CN, the first passenger information PJ1 and the second passenger information PJ2 corresponding to each of the plurality of contents C output by the content output unit 211.

The content control unit 215 determines whether the first passenger information PJ1 and the second passenger information PJ2 corresponding to each of the plurality of contents C output by the content output unit 211 match the passenger information PJ indicated by the instruction passenger name CN.

For example, when the first passenger information PJ1 and the second passenger information PJ2 corresponding to any one of the plurality of contents C output by the content output unit 211 match the passenger information PJ indicated by the instruction passenger name CN, the content control unit 215 executes the following processing. In other words, the content control unit 215 determines, from the plurality of contents C output by the content output unit 211, the content C to be output to the seat 1 on which the passenger P indicated by the instruction passenger name CN is seated, as the control target content Cα.

The content control unit 215 reads out, from the first passenger information storage unit 224, the first passenger information PJ1 corresponding to each of the plurality of contents C, that is, the content C1, the content C3, and the content C5, which are output by the content output unit 211. In addition, the content control unit 215 reads out, from the second passenger information storage unit 223, the second passenger information PJ2 corresponding to each of the plurality of contents C, that is, the content C1, the content C3, and the content C5, which are output by the content output unit 211.

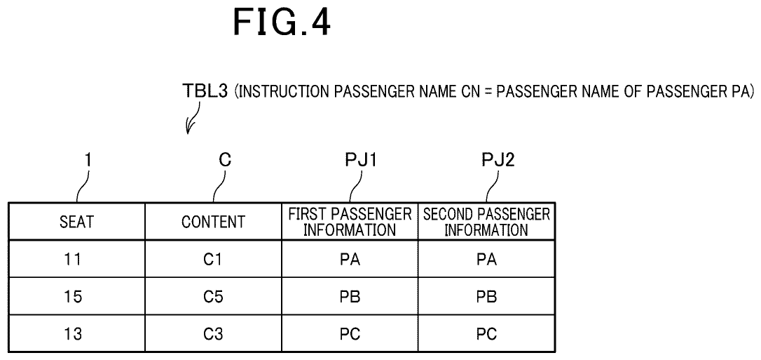

The above-described processing details of the content control unit 215 will now be described based on a specific example with reference to FIG. 4. FIG. 4 is a table illustrating an example of the first passenger information PJ1 and the second passenger information PJ2.

As illustrated in FIG. 4, a third table TBL3 illustrated in FIG. 4 lists the seat 1, the content C, the first passenger information PJ1, and the second passenger information PJ2.

As indicated in the third table TBL3, the content C1 is output to the first input/output mechanism 31 corresponding to the first seat 11. The content C3 is output to the third input/output mechanism 33 corresponding to the third seat 13. In addition, the content C5 is output to the fifth input/output mechanism 35 corresponding to the fifth seat 15.

Each of the first passenger information PJ1 and the second passenger information PJ2 corresponding to the content C1 is “PA”, which matches the passenger information PJ indicated by the instruction passenger name CN. Therefore, the content control unit 215 can specify the passenger P seated on the first seat 11 as the passenger PA. Therefore, content control unit 215 determines the content C1 to be output to the first seat 11 as the control target content Cα. Furthermore, the content control unit 215 changes the content C1 to be output to the passenger PA indicated by the instruction passenger name CN to “content Cβ”. In other words, the content control unit 215 causes the content output unit 211 to change the content C1 to be output to the passenger PA indicated by the instruction passenger name CN to “content Cβ”.

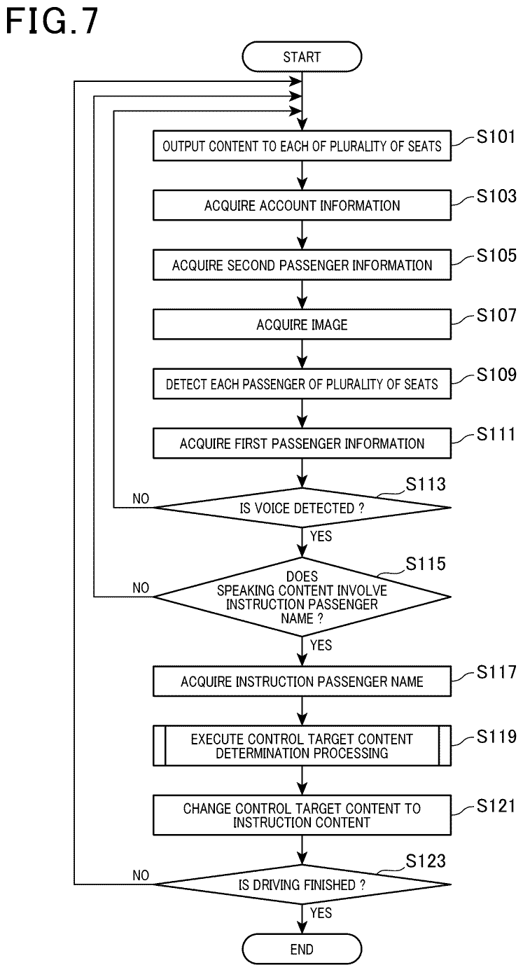

The processing of the content control unit 215 described with reference to FIG. 4 will be further described with reference to FIG. 7.

Returning to FIG. 2 again, the configuration of the content control unit 215 will be further described.

When the first passenger information PJ1 corresponding to any one of the plurality of contents C output by the content output unit 211 matches the passenger information PJ indicated by the instruction passenger name CN and the second passenger information PJ2 is not detected, the content control unit 215 executes the following processing. In other words, the content control unit 215 determines, out of the plurality of contents C output by the content output unit 211, the content C to be output to the seat 1 on which the passenger P indicated by the instruction passenger name CN is seated, as the control target content Cα.

In addition, when the second passenger information PJ2 corresponding to any one of the plurality of contents C output by the content output unit 211 matches the passenger information PJ indicated by the instruction passenger name CN and the first passenger information PJ1 is not detected, the content control unit 215 executes the following processing. In other words, the content control unit 215 determines, out of the plurality of contents C output by the content output unit 211, the content C to be output by the account information AT corresponding to the passenger P indicated by the instruction passenger name CN, as the control target content Cα.

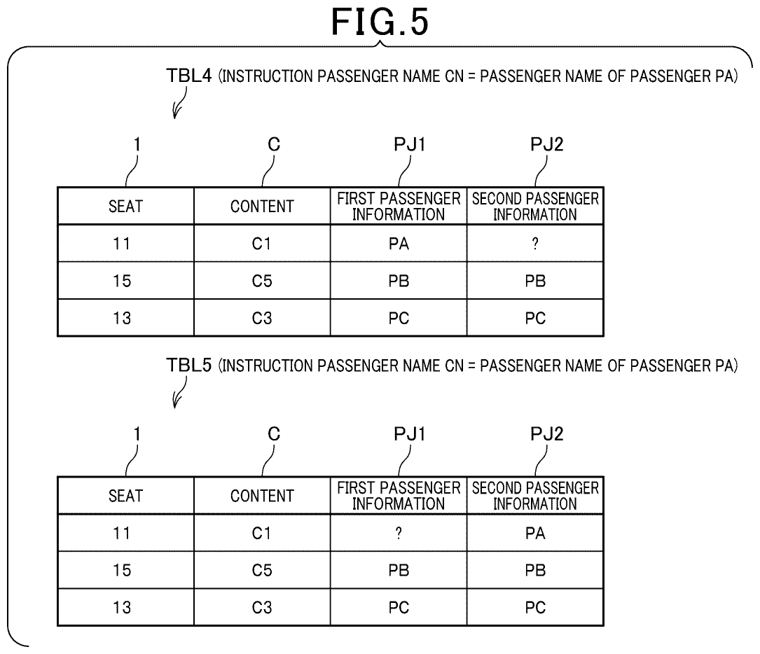

The above-described processing details of the content control unit 215 will now be described based on a specific example with reference to FIG. 5. FIG. 5 is a table illustrating other examples of the first passenger information PJ1 and the second passenger information PJ2.

As illustrated in FIG. 5, each of a fourth table TBL4 and a fifth table TBL5 illustrated in FIG. 5 lists the seat 1, the content C, the first passenger information PJ1, and the second passenger information PJ2.

As indicated in each of the fourth table TBL4 and the fifth table TBL5, the content C1 is output to the first input/output mechanism 31 corresponding to the first seat 11. The content C3 is output to the third input/output mechanism 33 corresponding to the third seat 13. In addition, the content C5 is output to the fifth input/output mechanism 35 corresponding to the fifth seat 15.

As indicated in the fourth table TBL4, the first passenger information PJ1 corresponding to the content C1 is “PA”, which matches the instruction passenger name CN. Furthermore, the second passenger information PJ2 corresponding to the content C1 is not set, as written as “?”.

In this case, the content control unit 215 can specify the passenger P seated on the first seat 11, as the passenger PA. Therefore, the content control unit 215 determines, as the control target content Cα, the content C1 to be output to the first seat 11.

Furthermore, the content control unit 215 changes the content C1 to be output to the passenger PA indicated by the instruction passenger name CN to “content Cβ”. In other words, the content control unit 215 causes the content output unit 211 to change the content C1 to be output to the passenger PA indicated by the instruction passenger name CN to “content Cβ”.

In addition, as indicated in the fifth table TBL5, the second passenger information PJ2 corresponding to the content C1 is “PA”, which matches the instruction passenger name CN. Furthermore, the first passenger information PJ1 corresponding to the content C1 is not detected, as written as “?”.

In this case, the content control unit 215 can specify the passenger P corresponding to the account information AT indicated by the second passenger information PJ2, as the passenger PA. Therefore, the content control unit 215 determines, as the control target content Cα, the content C1 to be output by the to the account information AT.

Furthermore, the content control unit 215 changes the content C1 to be output to the passenger PA indicated by the instruction passenger name CN to “content Cβ”. In other words, the content control unit 215 causes the content output unit 211 to change the content C1 to be output to the passenger PA indicated by the instruction passenger name CN to “content Cβ”.

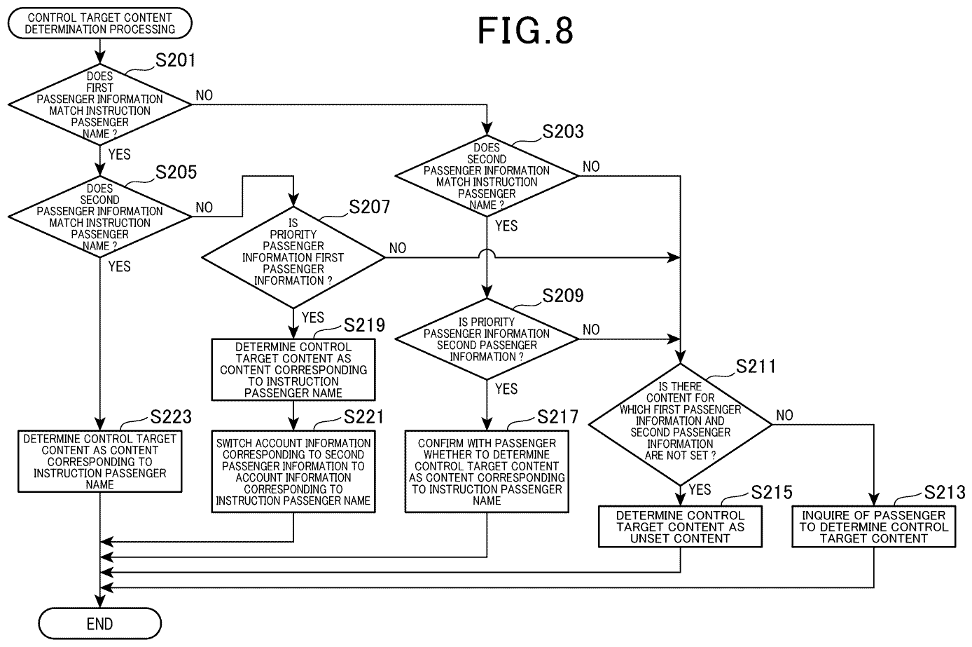

The processing of the content control unit 215 described with reference to FIG. 5 will be further described with reference to FIGS. 7 and 8.

As described above with reference to FIGS. 4 and 5, when at least one of the first passenger information PJ1 and the second passenger information PJ2 matches the instruction passenger name CN, the content control unit 215 can determine the content C to be output to the seat 1 on which the passenger P indicated by the instruction passenger name CN is seated, or the content C to be output by the account information AT corresponding to the passenger P indicated by the instruction passenger name CN. Therefore, the content C to be output to the seat 1 on which the passenger P indicated by the instruction passenger name CN is seated can be determined to be the control target content Cα.

For example, when the first passenger information PJ1 matches the instruction passenger name CN, the content control unit 215 determines that the content C to be output to the seat 1 on which the passenger P indicated by the instruction passenger name CN is seated is the content C corresponding to the first passenger information PJ1.

For example, when the second passenger information PJ2 matches the instruction passenger name CN, the content control unit 215 determines that the content C to be output by the account information AT corresponding to the passenger P indicated by the instruction passenger name CN is the content C corresponding to the second passenger information PJ2.

Returning to FIG. 2 again, the configuration of the content control unit 215 will be further described.

The content control unit 215 determines whether the first passenger information PJ1 and the second passenger information PJ2 corresponding to each of the plurality of contents C output by the content output unit 211 match the passenger information PJ indicated by the instruction passenger name CN.

For example, when one of the first passenger information PJ1 and the second passenger information PJ2 corresponding to any one of the plurality of contents C output by the content output unit 211 matches the passenger information PJ indicated by the instruction passenger name CN, and the other of the first passenger information PJ1 and the second passenger information PJ2 does not match the passenger information PJ indicated by the instruction passenger name CN, the content control unit 215 executes the following processing. In other words, the content control unit 215 selects which of the first passenger information PJ1 and the second passenger information PJ2 has the most recent detected date and time as priority passenger information PJA, and determines whether the priority passenger information PJA matches the passenger information PJ indicated by the instruction passenger name CN.

The content control unit 215 determines the priority passenger information PJA based on the first date-and-time information DT1 and the second date-and-time information DT2. The first date-and-time information DT1 indicates the date and time when the first passenger information PJ1 is detected by the passenger detection unit 213. The first date-and-time information DT1 is stored in the first passenger information storage unit 224. The second date-and-time information DT2 indicates the date and time when the account information AT is acquired by the account acquisition unit 212.

When the first date-and-time information DT1 indicates date and time later than the second date-and-time information DT2, the content control unit 215 determines the first passenger information PJ1 as the priority passenger information PJA. When the second date-and-time information DT2 indicates date and time later than the first date-and-time information DT1, the content control unit 215 determines the second passenger information PJ2 as the priority passenger information PJA.

In addition, the content control unit 215 determines whether the priority passenger information PJA matches the passenger information PJ indicated by the instruction passenger name CN.

When it is determined that the priority passenger information PJA does not match the passenger information PJ indicated by the instruction passenger name CN, the content control unit 215 does not determine that the content C to be output to the seat 1 on which the passenger P indicated by the instruction passenger name CN is seated is the control target content Cα.

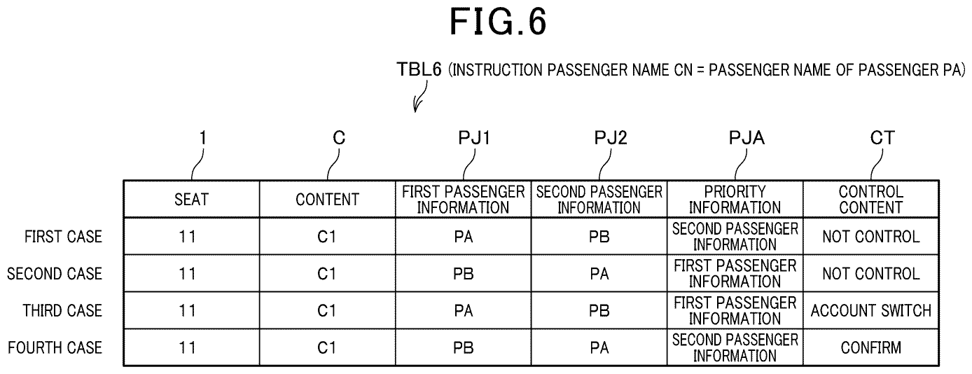

The above-described processing details of the content control unit 215 will now be described based on a specific example with reference to FIG. 6. FIG. 6 is a table illustrating further another example of the first passenger information PJ1 and the second passenger information PJ2, and the control content CT of the content control unit 215.

As illustrated in FIG. 6, each of a sixth table TBL6 illustrated in FIG. 6 lists the seat 1, the content C, the first passenger information PJ1, and the second passenger information PJ2. However, for convenience, the sixth table TBL6 indicated in FIG. 6 lists only the first passenger information PJ1 and the second passenger information PJ2 corresponding to the first seat 11 and the content C1, and does not list the first passenger information PJ1 and the second passenger information PJ2 corresponding to other seats and other contents.

The sixth table TBL6 indicated in FIG. 6 lists the priority passenger information PJA determined by the content control unit 215.

In a first case of the sixth table TBL6 indicated in FIG. 6, the first passenger information PJ1 corresponding to the first seat 11 and the content C1 is “PA”, and the second passenger information PJ2 corresponding to the first seat 11 and the content C1 is “PB”.

Therefore, the first passenger information PJ1 matches the passenger information PJ indicated by the instruction passenger name CN, and the second passenger information PJ2 does not match the passenger information PJ indicated by the instruction passenger name CN.

Furthermore, the priority passenger information PJA is the second passenger information PJ2. In other words, the content control unit 215 determines the second passenger information PJ2 as the priority passenger information PJA based on the first date-and-time information DT1 and the second date-and-time information DT2. In this case, the second date-and-time information DT2 indicates date and time later than the first date-and-time information DT1.

In the first case of the sixth table TBL6 indicated in FIG. 6, the content control unit 215 determines that the priority passenger information PJA, that is, the second passenger information PJ2 does not match the passenger information PJ indicated by the instruction passenger name CN. Then, as written as “do not control” in the control content CT, the content control unit 215 does not determine the content C to be output to the seat 1 on which the passenger P indicated by the instruction passenger name CN is seated, as the control target content Cα.

In a second case of the sixth table TBL6 indicated in FIG. 6, the first passenger information PJ1 corresponding to the first seat 11 and the content C1 is “PB”, and the second passenger information PJ2 corresponding to the first seat 11 and the content C1 is “PA”.

Therefore, the first passenger information PJ1 does not match the passenger information PJ indicated by the instruction passenger name CN, and the second passenger information PJ2 matches the passenger information PJ indicated by the instruction passenger name CN.

Furthermore, the priority passenger information PJA is the first passenger information PJ1. In other words, the content control unit 215 determines the first passenger information PJ1 as the priority passenger information PJA based on the first date-and-time information DT1 and the second date-and-time information DT2. In this case, the first date-and-time information DT1 indicates date and time later than the second date-and-time information DT2.

In the second case of the sixth table TBL6 indicated in FIG. 6, the content control unit 215 determines that the priority passenger information PJA, that is, the first passenger information PJ1 does not match the passenger information PJ indicated by the instruction passenger name CN. Then, as written as “do not control” in the control content CT, the content control unit 215 does not determine the content C to be output to the seat 1 on which the passenger P indicated by the instruction passenger name CN is seated, as the control target content Cα.

Returning to FIG. 2 again, the configuration of the content control unit 215 will be further described.

When the content control unit 215 determines that the priority passenger information PJA matches the passenger information PJ indicated by the instruction passenger name CN, and the priority passenger information PJA is the first passenger information PJ1, the content control unit 215 executes the following processing.

In other words, the content control unit 215 determines the content C to be output to the seat on which the passenger P indicated by the instruction passenger name CN is seated, as the control target content Cα.

In addition, the content control unit 215 switches the account information AT corresponding to the second passenger information PJ2 to the account information AT corresponding to the instruction passenger name CN.

Furthermore, when it is determined that the priority passenger information PJA matches the passenger information PJ indicated by the instruction passenger name CN and the priority passenger information PJA is the second passenger information PJ2, the content control unit 215 executes the following processing. In other words, the content control unit 215 inquires of the passenger P whether to determine the content C to be output to the seat 1 on which the passenger P indicated by the instruction passenger name CN is seated, as the control target content Cα.

When the seat 1 on which the passenger P indicated by the instruction passenger name CN is seated is the first seat 11, the content control unit 215 displays text information, for example, “Do you want to change the content to be output to the driver's seat?” on the touch panel TP, and accepts instructions from the passenger P.

When a response of the passenger P to the inquiry indicates permission, the content control unit 215 determines the content C to be output to the seat 1 on which the passenger P indicated by the instruction passenger name CN is seated, as the control target content Cα.

When it is determined that the priority passenger information PJA matches the passenger information PJ indicated by the instruction passenger name CN and the priority passenger information PJA is the first passenger information PJ1, the content control unit 215 may execute the following processing.

In other words, the content control unit 215 determines whether the account information AT corresponding to the instruction passenger name CN matches all of the account information AT in comparison with the account information AT corresponding to each of the plurality of contents C output by the content output unit 211. Then, when it is determined that the account information AT corresponding to the instruction passenger name CN does not match all of the account information AT in comparison with the account information AT corresponding to each of the plurality of contents C output by the content output unit 211, the content control unit 215 further executes the following processing. In other words, the content control unit 215 inquires of the passenger P whether to determine the content C to be output to the seat 1 on which the passenger P indicated by the instruction passenger name CN is seated, as the control target content Cα.

When the seat 1 on which the passenger P indicated by the instruction passenger name CN is seated is the first seat 11, the content control unit 215 displays text information, for example, “Do you want to change the content to be output to the driver's seat?” on the touch panel TP, and accepts instructions from the passenger P.

The above-described processing details of the content control unit 215 will now be described based on a specific example with reference to FIG. 6. FIG. 6 is a table illustrating further another example of the first passenger information PJ1 and the second passenger information PJ2, and the control content CT of the content control unit 215.

As illustrated in FIG. 6, the sixth table TBL6 illustrated in FIG. 6 lists the seat 1, the content C, the first passenger information PJ1, and the second passenger information PJ2. However, for convenience, the sixth table TBL6 indicated in FIG. 6 lists only the first passenger information PJ1 and the second passenger information PJ2 corresponding to the first seat 11 and the content C1, and does not list the first passenger information PJ1 and the second passenger information PJ2 corresponding to other seats and other contents.

The sixth table TBL6 indicated in FIG. 6 lists the priority passenger information PJA determined by the content control unit 215.

In a third case of the sixth table TBL6 indicated in FIG. 6, the first passenger information PJ1 corresponding to the first seat 11 and the content C1 is “PA”, and the second passenger information PJ2 corresponding to the first seat 11 and the content C1 is “PB”.

Therefore, the first passenger information PJ1 matches the passenger information PJ indicated by the instruction passenger name CN, and the second passenger information PJ2 does not match the passenger information PJ indicated by the instruction passenger name CN.

Furthermore, the priority passenger information PJA is the first passenger information PJ1. In other words, the content control unit 215 determines the first passenger information PJ1 as the priority passenger information PJA based on the first date-and-time information DT1 and the second date-and-time information DT2. In this case, the first date-and-time information DT1 indicates date and time later than the second date-and-time information DT2.

In the third case of the sixth table TBL6 indicated in FIG. 6, the content control unit 215 determines that the priority passenger information PJA, that is, the first passenger information PJ1 matches the passenger information PJ indicated by the instruction passenger name CN. The content control unit 215 determines the content C to be output to the seat on which the passenger P indicated by the instruction passenger name CN is seated, as the control target content Cα. As written as “account switching” in the control content CT, the content control unit 215 switches the account information AT corresponding to the second passenger information PJ2 to the account information AT corresponding to the instruction passenger name CN.

In other words, the content control unit 215 causes the content output unit 211 to switch the account information AT logged in to the first server device 51 to the account information AT corresponding to the instruction passenger name CN from the account information AT corresponding to the second passenger information PJ2. Then, the content control unit 215 causes the content output unit 211 to determine the content C to be output to the seat on which the passenger P indicated by the instruction passenger name CN is seated, as the control target content Cα.

In a fourth case of the sixth table TBL6 indicated in FIG. 6, the first passenger information PJ1 corresponding to the first seat 11 and the content C1 is “PB”, and the second passenger information PJ2 corresponding to the first seat 11 and the content C1 is “PA”.

Therefore, the first passenger information PJ1 does not match the passenger information PJ indicated by the instruction passenger name CN, and the second passenger information PJ2 matches the passenger information PJ indicated by the instruction passenger name CN.

Furthermore, the priority passenger information PJA is the second passenger information PJ2. In other words, the content control unit 215 determines the second passenger information PJ2 as the priority passenger information PJA based on the first date-and-time information DT1 and the second date-and-time information DT2. In this case, the second date-and-time information DT2 indicates date and time later than the first date-and-time information DT1.

In the fourth case of the sixth table TBL6 indicated in FIG. 6, the content control unit 215 determines that the priority passenger information PJA, that is, the second passenger information PJ2 matches the passenger information PJ indicated by the instruction passenger name CN. Then, as written as “confirm” in the control content CT, the content control unit 215 inquires of the passenger P whether to determine the content C to be output by the account information AT corresponding to the passenger PA indicated by the instruction passenger name CN, as the control target content Cα.

When the response of the passenger P to the inquiry indicates permission, the content control unit 215 determines the content C to be output by the account information AT corresponding to the passenger PA indicated by the instruction passenger name CN, as the control target content Cα. Furthermore, the content control unit 215 changes the content C to be output by the account information AT corresponding to the passenger PA indicated by the instruction passenger name CN to “content Cβ”. In other words, the content control unit 215 causes the content output unit 211 to change the content C to be output to the passenger PA indicated by the instruction passenger name CN to “content Cβ”.

Returning to FIG. 2 again, the configuration of the content control unit 215 will be further described.

In a case where each of the first passenger information PJ1 and the second passenger information PJ2 does not match the instruction passenger name CN, when there is a content C for which each of the first passenger information PJ1 and the second passenger information PJ2 is not set, out of the plurality of contents C output by the content output unit 211, the content control unit 215 executes the following processing. In other words, the content control unit 215 determines the content C for which each of the first passenger information PJ1 and the second passenger information PJ2 is not set, as the control target content Cα. Then, the content control unit 215 causes the content output unit 211 to change the content C for which each of the first passenger information PJ1 and the second passenger information PJ2 is not set, to “content Cβ”.

Furthermore, in the case where each of the first passenger information PJ1 and the second passenger information PJ2 does not match the instruction passenger name CN, when there are a plurality of contents C for which each of the first passenger information PJ1 and the second passenger information PJ2 is not set, out of the plurality of contents C output by the content output unit 211, the content control unit 215 executes the following processing. In other words, the content control unit 215 inquires of the passenger P which content C, among the plurality of contents C, is determined to be the control target content Cα.

For example, the instruction content name CS indicating each of the plurality of contents C and text information such as “Please specify the content to be changed.” are displayed on the touch panel TP, and instructions from the passenger P are accepted.

When the instructions from the passenger P are accepted, the content control unit 215 determines the content C instructed by the passenger P as the control target content Cα. Then, the content control unit 215 causes the content output unit 211 to change the content C instructed by the passenger P to “content Cβ”.

### [4. Processing of Content Control Device]

Next, processing of the content control device 2 will be described with reference to FIGS. 7 and 8. FIG. 7 is a flowchart illustrating an example of the processing of the content control device 2. The association storage unit 222 stores in advance the first table TBL1 and the second table TBL2 described with reference to FIG. 3.

First, in step S101, the content output unit 211 downloads the content C from the server device 5 based on instructions from the passenger P seated on each of the plurality of seats 1, and outputs the content C from the input/output mechanism 3 corresponding to each of the plurality of seats 1.

Next, in step S103, the account acquisition unit 212 acquires the account information AT logged in to the server device 5 such that the content output unit 211 downloads the content C from the server device 5. Next, in step S105, when acquiring the account information AT, the account acquisition unit 212 refers to the association storage unit 222 and acquires the second passenger information PJ2 indicating the passenger P corresponding to the account information AT.

Next, in step S107, the passenger detection unit 213 acquires an image PT from the camera 4.

Next, in step S109, the passenger detection unit 213 performs, for example, image recognition processing on the image PT to detect the passenger P seated on the seat 1 corresponding to each of the plurality of contents C output by the content output unit 211.

Next, in step S111, the passenger detection unit 213 acquires first passenger information PJ1 indicating the detection result of the passenger P seated on the seat 1 corresponding to each of the plurality of contents C.

Next, in step S113, the voice detection unit 214 acquires, from the speaker SP, voice spoken by the passenger P, and performs, for example, voice recognition processing on the acquired voice to determine whether the speaking content of the passenger P has been detected.

When the voice detection unit 214 determines that the speaking content of the passenger P has not been detected (step S113; NO), the process returns to step S101. When the voice detection unit 214 determines that the speaking content of the passenger P has been detected (step S113; YES), the process proceeds to step S115.

Then, in step S115, the voice detection unit 214 determines whether the speaking content of the passenger P involves an instruction passenger name CN. The instruction passenger name CN is a name of the passenger P indicating the target passenger P to whom a change in the content C is to be instructed.

When the voice detection unit 214 determines that the speaking content of the passenger P does not involve the instruction passenger name CN (step S115; NO), the process returns to step S101. When the voice detection unit 214 determines that the speaking content of the passenger P involves the instruction passenger name CN (step S115; YES), the process proceeds to step S117.

Then, in step S117, the voice detection unit 214 acquires the instruction passenger name CN and the instruction content name CS. The instruction content name CS indicates a content Cβ after change.

Next, in step S119, the content control unit 215 executes “control target content determination processing”. The “control target content determination processing” is processing for determining a control target content Cα, which is the content C to be controlled based on the speaking content detected by the voice detection unit 214, based on the instruction passenger name CN, the first passenger information PJ1, and the second passenger information PJ2. The “control target content determination processing” will be further described with reference to FIG. 8.

Next, in step S121, the content control unit 215 causes the content output unit 211 to change the control target content Cα to the content Cβ.

Next, in step S123, the content control device 2 determines whether driving of the vehicle 100 is finished.

When the content control device 2 determines that the driving of the vehicle 100 is not finished (step S123; NO), the process returns to step S101. When the content control device 2 determines that the driving of the vehicle 100 is finished (step S123; YES), the process then ends.

Step S119 corresponds to an example of a “determination step”.

Next, the “control target content determination processing” will be described with reference to FIG. 8. FIG. 8 is a flowchart illustrating an example of the “control target content determination processing” of the content control device 2.

First, in step S201, the content control unit 215 determines whether the first passenger information PJ1 corresponding to each of the plurality of contents C output by the content output unit 211 matches the passenger information PJ indicated by the instruction passenger name CN.

When the content control unit 215 determines that the first passenger information PJ1 matches the passenger information PJ indicated by the instruction passenger name CN (step S201; YES), the process proceeds to step S205. When the content control unit 215 determines that the first passenger information PJ1 does not match the passenger information PJ indicated by the instruction passenger name CN (step S201; NO), the process proceeds to step S203.

Then, in step S203, the content control unit 215 determines whether the second passenger information PJ2 corresponding to each of the plurality of contents C output by the content output unit 211 matches the passenger information PJ indicated by the instruction passenger name CN.

When the content control unit 215 determines that the second passenger information PJ2 matches the passenger information PJ indicated by the instruction passenger name CN (step S203; YES), the process proceeds to step S209.

Then, in step S209, the content control unit 215 determines whether the priority passenger information PJA is the second passenger information PJ2.

When the content control unit 215 determines that the priority passenger information PJA is not the second passenger information PJ2 (step S209; NO), the process proceeds to step S211. When the content control unit 215 determines that the priority passenger information PJA is the second passenger information PJ2 (step S209; YES), the process proceeds to step S217.

Then, in step S217, the content control unit 215 confirms with the passenger whether to determine the control target content Cα as the content C corresponding to the passenger information PJ indicated by the instruction passenger name CN. Then, the content control unit 215 determines the content C according to the instruction of the passenger. Thereafter, the process returns to step S121 in FIG. 7.

When the content control unit 215 determines that the second passenger information PJ2 does not match the passenger information PJ indicated by the instruction passenger name CN (step S203; NO), the process proceeds to step S211.

In a case of YES in step S201, the content control unit 215 determines in step S205 whether the second passenger information PJ2 corresponding to each of the plurality of contents C output by the content output unit 211 matches the passenger information PJ indicated by the instruction passenger name CN.

When the content control unit 215 determines that the second passenger information PJ2 matches the passenger information PJ indicated by the instruction passenger name CN (step S205; YES), the process proceeds to step S223. When the content control unit 215 determines that the second passenger information PJ2 does not match the passenger information PJ indicated by the instruction passenger name CN (step S205; NO), the process proceeds to step S207.

Then, in step S207, the content control unit 215 determines whether the priority passenger information PJA is the first passenger information PJ1.

When the content control unit 215 determines that the priority passenger information PJA is the first passenger information PJ1 (step S207; YES), the process proceeds to step S217. When the content control unit 215 determines that the priority passenger information PJA is not the first passenger information PJ1 (step S207; NO), the process proceeds to step S211.

Then, in step S211, the content control unit 215 determines whether there is any content C for which the first passenger information PJ1 and the second passenger information PJ2 are not set, out of the plurality of contents C output by the content output unit 211.

When the content control unit 215 determines that there is no content C for which the first passenger information PJ1 and the second passenger information PJ2 are not set (step S211; NO), the process proceeds to step S213.

Then, in step S213, the content control unit 215 inquires of the passenger P, and determines the control target content Cα according to the response from the passenger P. Thereafter, the process returns to step S121 in FIG. 7.

When the content control unit 215 determines that there is a content C for which the first passenger information PJ1 and the second passenger information PJ2 are not set (step S211; YES), the process proceeds to step S215.

Then, in step S215, the content control unit 215 determines the control target content Cα as the content C for which the first passenger information PJ1 and the second passenger information PJ2 are not set. Thereafter, the process returns to step S121 in FIG. 7.

In a case of YES in step S209, the content control unit 215 confirms, in step S217, with the passenger P whether to determine the control target content Cα as the content C corresponding to the passenger information PJ indicated by the instruction passenger name CN. Then, the content control unit 215 determines the control target content Cα according to instructions from the passenger P. Thereafter, the process returns to step S121 in FIG. 7.

In a case of YES in step S207, the content control unit 215 determines in step S219 the control target content Cα as the content C corresponding to the passenger information PJ indicated by the instruction passenger name CN.

Next, in step S221, the content control unit 215 switches the account information AT corresponding to the second passenger information PJ2 to the account information AT corresponding to the instruction passenger name CN. Thereafter, the process returns to step S121 in FIG. 7.

In a case of YES in step S205, the content control unit 215 determines in step S223 the control target content Cα as the content C corresponding to the passenger information PJ indicated by the instruction passenger name CN. Thereafter, the process returns to step S121 in FIG. 7.

### [5. Configurations and Effects]

As described with reference to FIGS. 1 to 8, the content control device 2 according to the present embodiment includes: the content output unit 211 that outputs the content C to each of the plurality of seats 1 arranged in the vehicle 100; the voice detection unit 214 that detects the speaking content of the passenger P in the vehicle 100; the content control unit 215 that controls the content output unit 211 based on the speaking content detected by the voice detection unit 214; and the passenger detection unit 213 that detects the passenger P seated on each of the plurality of seats 1, and when the speaking content involves the instruction passenger name CN indicating the target passenger P to whom a change in the content C is to be instructed, the content control unit 215 determines the control target content Cα, which is the content C to be controlled based on the speaking content, based on the instruction passenger name CN, the first passenger information PJ1 detected by the passenger detection unit 213 and indicating the passenger P seated on the seat 1 corresponding to each of the plurality of contents C output by the content output unit 211, and the account information AT corresponding to each of the plurality of contents C output by the content output unit 211.

According to such a configuration, the control target content Cα, which is the content C to be controlled based on the speaking content, is determined based on the instruction passenger name CN, the first passenger information PJ1, and the account information AT, whereby the control target content Cα can be determined appropriately.

In the content control device 2, the content control unit 215 determines the control target content Cα based on the instruction passenger name CN, the first passenger information PJ1, and the second passenger information PJ2 indicating the passenger corresponding to the account information AT.

According to such a configuration, the control target content Cα, which is the content C to be controlled based on the speaking content, is determined based on the instruction passenger name CN, the first passenger information PJ1, and the second passenger information PJ2, whereby the control target content Cα can be determined appropriately.

In the content control device 2, when the first passenger information PJ1 and the second passenger information PJ2 match the instruction passenger name CN, the content control unit 215 determines, from the plurality of contents C output by the content output unit 211, the content C to be output to the seat 1 on which the passenger P indicated by the instruction passenger name CN is seated, as the control target content Cα.

According to such a configuration, when the first passenger information PJ1 and the second passenger information PJ2 match the instruction passenger name CN, the content to be output to the seat on which the passenger indicated by the instruction passenger name CN is seated is determined to be the control target content Cα, whereby the control target content Cα can be determined appropriately.

In the content control device 2, when the first passenger information PJ1 matches the instruction passenger name CN and the second passenger information PJ2 is not detected, the content control unit 215 determines, from the plurality of contents C output by the content output unit 211, the content C to be output to the seat 1 on which the passenger P indicated by the instruction passenger name CN is seated, as the control target content Cα, and when the first passenger information PJ1 is not detected and the second passenger information PJ2 matches the instruction passenger name CN, the content control unit 215 determines, from the plurality of contents C output by the content output unit 211, the content C to be output by the account information AT corresponding to the passenger P indicated by the instruction passenger name CN, as the control target content Cα.

According to such a configuration, when the first passenger information PJ1 matches the instruction passenger name CN and the second passenger information PJ2 is not detected, the content C to be output to the seat 1 on which the passenger P indicated by the instruction passenger name CN is seated is determined to be the control target content Cα, whereby the control target content Cα can be determined appropriately. In addition, when the first passenger information PJ1 is not detected and the second passenger information PJ2 matches the instruction passenger name CN, the content C to be output by the account information AT corresponding to the passenger P indicated by the instruction passenger name CN is determined to be the control target content Cα, whereby the control target content Cα can be determined appropriately.

In the content control device 2, when one of the first passenger information PJ1 and the second passenger information PJ2 matches the instruction passenger name CN and the other of the first passenger information PJ1 and the second passenger information PJ2 does not match the instruction passenger name CN, the content control unit 215 selects, as the priority passenger information PJA, which of the first passenger information PJ1 and the second passenger information PJ2 has the most recent detected date and time, and determines whether the priority passenger information PJA matches the instruction passenger name CN.

According to such a configuration, the information with the most recent detected date and time is selected as the priority passenger information PJA from the first passenger information PJ1 and the second passenger information PJ2, and the determination is made as to whether the priority passenger information PJA matches the instruction passenger name CN, whereby the control target content Cα can be determined appropriately based on the determination result.

In the content control device 2, when the content control unit 215 determines that the priority passenger information PJA does not match the instruction passenger name CN, the content control unit 215 does not determine the content C to be output to the seat 1 on which the passenger P indicated by the instruction passenger name CN is seated, as the control target content Cα.

According to such a configuration, when the priority passenger information PJA does not match the instruction passenger name CN, the determination can be appropriately made that the content C to be output to the seat 1, on which the passenger P indicated by the instruction passenger name CN is seated, is not determined as the control target content Cα.

In the content control device 2, when the content control unit 215 determines that the priority passenger information PJA matches the instruction passenger name CN and the priority passenger information PJA is the first passenger information PJ1, the content control unit 215 determines the content C to be output to the seat 1, on which the passenger P indicated by the instruction passenger name CN is seated, as the control target content Cα.

According to such a configuration, when it is determined that the priority passenger information PJA matches the instruction passenger name CN and the priority passenger information PJA is the first passenger information PJ1, the content C to be output to the seat 1 on which the passenger P indicated by the instruction passenger name CN is seated is determined to be the control target content Cα, whereby the control target content Cα can be determined appropriately.

In the content control device 2, when the content control unit 215 determines that the priority passenger information PJA matches the instruction passenger name CN and the priority passenger information PJA is the first passenger information PJ1, the content control unit 215 switches the account information AT corresponding to the second passenger information PJ2 to the account information AT corresponding to the instruction passenger name CN.

According to such a configuration, when it is determined that the priority passenger information PJA matches the instruction passenger name CN and the priority passenger information PJA is the first passenger information PJ1, the account information AT corresponding to the second passenger information PJ2 is switched to the account information AT corresponding to the instruction passenger name CN, whereby the account information AT corresponding to the second passenger information PJ2 can be switched to the appropriate account information AT.

In the content control device 2, when the content control unit 215 determines that the priority passenger information PJA matches the instruction passenger name CN and the priority passenger information PJA is the second passenger information PJ2, the content control unit 215 inquires of the passenger P whether to determine the content C to be output by the account information AT corresponding to the passenger P indicated by the instruction passenger name CN, as the control target content Cα.

According to such a configuration, when it is determined that the priority passenger information PJA matches the instruction passenger name CN and the priority passenger information PJA is the second passenger information PJ2, the content control unit 215 inquires of the passenger P whether to determine the content C to be output by the account information AT corresponding to the passenger P indicated by the instruction passenger name CN, as the control target content Cα. Therefore, the control target content Cα can be determined appropriately according to the response from the passenger P.

In the content control device 2, when the response of the passenger P to the inquiry to the passenger P indicates permission, the content C to be output by the account information AT corresponding to the passenger P indicated by the instruction passenger name CN is determined as the control target content Cα.

According to such a configuration, when the response of the passenger P to the inquiry to the passenger P indicates permission, the content C to be output by the account information AT corresponding to the passenger P indicated by the instruction passenger name CN is determined as the control target content Cα, and thus the control target content Cα can be determined appropriately.

In the content control device 2, when the content control unit 215 determines that the priority passenger information PJA matches the instruction passenger name CN and the priority passenger information PJA is the first passenger information PJ1, and when the account information AT corresponding to the instruction passenger name CN does not match all of the account information AT in comparison with the account information AT corresponding to each of the plurality of contents C output by the content output unit 211, the content control unit 215 inquires of the passenger P whether to switch the account information AT corresponding to the second passenger information PJ2 to the account information AT corresponding to the instruction passenger name CN.

According to such a configuration, when it is determined that the priority passenger information PJA matches the instruction passenger name CN and the priority passenger information PJA is the first passenger information PJ1, and when the account information AT corresponding to the instruction passenger name CN does not match all of the account information AT in comparison with the account information AT corresponding to each of the plurality of contents C output by the content output unit 211, the content control unit 215 inquires of the passenger P whether to switch the account information AT corresponding to the second passenger information PJ2 to the account information AT corresponding to the instruction passenger name CN. Therefore, it is possible to appropriately determine whether to switch the account information AT corresponding to the second passenger information PJ2 to the account information AT corresponding to the instruction passenger name CN according to the response from the passenger.

In the content control device 2, when each of the first passenger information PJ1 and the second passenger information PJ2 does not match the instruction passenger name CN, and when there is the content C for which each of the first passenger information PJ1 and the second passenger information PJ2 is not set, out of the plurality of contents C output by the content output unit 211, the content control unit 215 determines the content C for which each of the first passenger information PJ1 and the second passenger information PJ2 is not set, as the control target content Cα.

According to such a configuration, when each of the first passenger information PJ1 and the second passenger information PJ2 does not match the instruction passenger name CN, and when there is the content C for which each of the first passenger information PJ1 and the second passenger information PJ2 is not set, out of the plurality of contents C output by the content output unit 211, the content C for which each of the first passenger information PJ1 and the second passenger information PJ2 is not set, is determined as the control target content Cα. Therefore, the control target content Cα can be determined appropriately.

In the content control device 2, when each of the first passenger information PJ1 and the second passenger information PJ2 does not match the instruction passenger name CN, and when there are a plurality of contents C for which each of the first passenger information PJ1 and the second passenger information PJ2 is not set, out of the plurality of contents C output by the content output unit 211, the content control unit 215 inquires of the passenger P which content C, among the plurality of contents C, is determined to be the control target content Cα.

According to such a configuration, when each of the first passenger information PJ1 and the second passenger information PJ2 does not match the instruction passenger name CN, and when there are a plurality of contents C for which each of the first passenger information PJ1 and the second passenger information PJ2 is not set, out of the plurality of contents C output by the content output unit 211, the content control unit 215 inquires of the passenger P which content C, among the plurality of contents C, is determined to be the control target content Cα. Therefore, the control target content Cα can be determined appropriately according to the response from the passenger P.

The content control method according to the present embodiment is performed by the content control device 2 including: the content output unit 211 that outputs the content C to each of the plurality of seats 1 arranged in the vehicle 100; the voice detection unit 214 that detects the speaking content of the passenger P in the vehicle 100; the content control unit 215 that controls the content output unit 211 based on the speaking content detected by the voice detection unit 214; and the passenger detection unit 213 that detects the passenger P seated on each of the plurality of seats 1, and when the speaking content involves the instruction passenger name CN indicating the target passenger P to whom a change in the content C is to be instructed, the content control unit 215 executes a determining step of determining the control target content Cα, which is the content C to be controlled based on the speaking content, based on the instruction passenger name CN, the first passenger information PJ1 detected by the passenger detection unit 213 and indicating the passenger P seated on the seat 1 corresponding to each of the plurality of contents C output by the content output unit 211, and the account information AT corresponding to each of the plurality of contents C output by the content output unit 211.

Therefore, the content control method according to the present embodiment has the same operational effects as the content control device 2 according to the present embodiment.

The control program PG according to the present embodiment causes the processor 21 included in the content control device 2 to function as: the content output unit 211 that outputs the content C to each of the plurality of seats 1 arranged in the vehicle 100; the voice detection unit 214 that detects the speaking content of the passenger P in the vehicle 100; the content control unit 215 that controls the content output unit 211 based on the speaking content detected by the voice detection unit 214; and the passenger detection unit 213 that detects the passenger P seated on each of the plurality of seats 1, and when the speaking content involves the instruction passenger name CN indicating the target passenger P to whom a change in the content C is to be instructed, the content control unit 215 determines the control target content Cα, which is the content C to be controlled based on the speaking content, based on the instruction passenger name CN, the first passenger information PJ1 detected by the passenger detection unit 213 and indicating the passenger P seated on the seat 1 corresponding to each of the plurality of contents C output by the content output unit 211, and the account information AT corresponding to each of the plurality of contents C output by the content output unit 211.

Therefore, the control program PG according to the present embodiment has the same operational effects as the content control device 2 according to the present embodiment.

### 6. Other Embodiments

The above-described embodiment is a preferred embodiment of the present invention. However, the present invention is not limited to the above-described embodiment, and various modifications are possible within the scope of the gist of the present invention.

In the present embodiment, a case has been described in which one camera 4 generates the image PT, but embodiments are not limited thereto. A plurality of cameras 4 may generate the image PT. For example, a camera 4 may be arranged in each of the first input/output mechanism 31, the second input/output mechanism 32, the third input/output mechanism 33, the fourth input/output mechanism 34, and the fifth input/output mechanism 35.

In the present embodiment, a case has been described in which the seat 1 is constituted by five seats, that is, the first seat 11, the second seat 12, the third seat 13, the fourth seat 14, and the fifth seat 15, but embodiments are not limited thereto. The seat 1 may be constituted by three seats, for example. The seat 1 may be constituted by four seats, for example. The seat 1 may be constituted by six or more seats, for example.

In the present embodiment, a case has been described in which there are three passengers P, that is, the passenger PA, the passenger PB, and the passenger PC, but embodiments are not limited thereto. There may be a plurality of passengers P. For example, there may be two passengers P. Furthermore, there may be four or more passengers P, for example.

In the present embodiment, a case has been described in which the content C includes the image information and the voice information, but embodiments are not limited thereto. For example, the content C may include voice information but not include image information. For example, the content C may include image information but not include voice information.

In the present embodiment, a case has been described in which the input/output mechanism 3 includes the touch panel TP, the speaker SP, and the microphone MC, but embodiments are not limited thereto. For example, the touch panel TP and the speaker SP may be arranged in one housing, and the microphone MC may be arranged in another housing.

For example, the content control device 2 illustrated in FIG. 2 shows a functional configuration, and the specific implementation form is not particularly limited. In other words, it is not necessarily required to implement hardware corresponding to respective components, but it is of course possible to construct a configuration in which the functions of the respective components are implemented by executing a program by one processor. In addition, some of the functions implemented by software in the above-described embodiment may be implemented by hardware, or some of the functions implemented by hardware may be implemented by software.

Further, for example, the processing units in the flowcharts illustrated in FIGS. 7 and 8 are divided according to the main processing contents to make the processing of the content control device 2 easier to understand, and the present invention is not limited by the manner in which the processing units are divided or the names of the processing units illustrated in the flowcharts of FIGS. 7 and 8. The processing of the content control device 2 may be divided into more processing units depending on the processing contents, or one processing unit may be divided so as to include more processing. In addition, the processing order of the above flowchart is not also limited to the example illustrated in the drawings.

### 7. Configuration Supported by Embodiment

The above-described embodiment supports the following configurations.

### (Configuration 1)

A content control device including: a content output unit that outputs a content to each of a plurality of seats arranged in a vehicle; a voice detection unit that detects a speaking content of a passenger in the vehicle; a content control unit that controls the content output unit based on the speaking content detected by the voice detection unit; and a passenger detection unit that detects a passenger seated on each of the plurality of seats, in which, when the speaking content involves an instruction passenger name indicating a target passenger to whom a change in the content is to be instructed, the content control unit determines a control target content, which is a content to be controlled based on the speaking content, based on the instruction passenger name, first passenger information detected by the passenger detection unit and indicating the passenger seated on the seat corresponding to each of the plurality of contents output by the content output unit, and account information corresponding to each of the plurality of contents output by the content output unit.

According to the content control device of Configuration 1, the control target content, which is the content to be controlled based on the speaking content, is determined based on the instruction passenger name, the first passenger information, and the account information, whereby the control target content can be determined appropriately.

### (Configuration 2)

In the content control device according to Configuration 1, the content control unit determines the control target content based on the instruction passenger name, the first passenger information, and second passenger information indicating a passenger corresponding to the account information.

According to the content control device of Configuration 2, the control target content, which is the content to be controlled based on the speaking content, is determined based on the instruction passenger name, the first passenger information, and the second passenger information, whereby the control target content can be determined appropriately.

### (Configuration 3)

In the content control device according to Configuration 2, when the first passenger information and the second passenger information match the instruction passenger name, the content control unit determines, from the plurality of contents output by the content output unit, a content to be output to a seat on which a passenger indicated by the instruction passenger name is seated, as the control target content.

According to the content control device of Configuration 3, when the first passenger information and the second passenger information match the instruction passenger name, the content to be output to the seat on which the passenger indicated by the instruction passenger name is seated is determined to be the control target content, whereby the control target content can be determined appropriately.

### (Configuration 4)

In the content control device according to Configuration 2 or 3, when the first passenger information matches the instruction passenger name and the second passenger information is not detected, the content control unit determines, from the plurality of contents output by the content output unit, the content to be output to the seat on which the passenger indicated by the instruction passenger name is seated, as the control target content, and when the first passenger information is not detected and the second passenger information matches the instruction passenger name, the content control unit determines, from the plurality of contents output by the content output unit, the content to be output by the account information corresponding to the passenger indicated by the instruction passenger name, as the control target content.

According to the content control device of Configuration 4, when the first passenger information matches the instruction passenger name and the second passenger information is not detected, the content to be output to the seat on which the passenger indicated by the instruction passenger name is seated is determined to be the control target content, whereby the control target content can be determined appropriately. In addition, when the first passenger information is not detected and the second passenger information matches the instruction passenger name, the content to be output by the account information corresponding to the passenger indicated by the instruction passenger name is determined to be the control target content, whereby the control target content can be determined appropriately.

### (Configuration 5)

In the content control device according to any one of Configurations 2 to 4, when one of the first passenger information and the second passenger information matches the instruction passenger name and the other of the first passenger information and the second passenger information does not match the instruction passenger name, the content control unit selects, as priority passenger information, which of the first passenger information and the second passenger information has the most recent detected date and time, and determines whether the priority passenger information matches the instruction passenger name.

According to the content control device of Configuration 5, the information with the most recent detected date and time is selected as the priority passenger information from the first passenger information and the second passenger information, and the determination is made as to whether the priority passenger information matches the instruction passenger name, whereby the control target content can be determined appropriately based on the determination result.

### (Configuration 6)

In the content control device according to Configuration 5, when the content control unit determines that the priority passenger information does not match the instruction passenger name, the content control unit does not determine the content to be output to the seat on which the passenger indicated by the instruction passenger name is seated, as the control target content.

According to the content control device of Configuration 6, when the priority passenger information does not match the instruction passenger name, the determination can be appropriately made that the content to be output to the seat, on which the passenger indicated by the instruction passenger name is seated, is not determined as the control target content.

### (Configuration 7)

In the content control device according to Configuration 5 or 6, when the content control unit determines that the priority passenger information matches the instruction passenger name and the priority passenger information is the first passenger information, the content control unit determines the content to be output to the seat, on which the passenger indicated by the instruction passenger name is seated, as the control target content.

According to the content control device of Configuration 7, when it is determined that the priority passenger information matches the instruction passenger name and the priority passenger information is the first passenger information, the content to be output to the seat on which the passenger indicated by the instruction passenger name is seated is determined to be the control target content, whereby the control target content can be determined appropriately.

### (Configuration 8)

In the content control device according to any one of Configurations 5 to 7, when the content control unit determines that the priority passenger information matches the instruction passenger name and the priority passenger information is the first passenger information, the content control unit switches the account information corresponding to the second passenger information to account information corresponding to the instruction passenger name.

According to the content control device of Configuration 8, when it is determined that the priority passenger information matches the instruction passenger name and the priority passenger information is the first passenger information, the account information corresponding to the second passenger information is switched to the account information corresponding to the instruction passenger name, whereby the account information corresponding to the second passenger information can be switched to the appropriate account information.

### (Configuration 9)

In the content control device according to any one of Configurations 5 to 8, when the content control unit determines that the priority passenger information matches the instruction passenger name and the priority passenger information is the second passenger information, the content control unit inquires of the passenger whether to determine the content to be output by the account information corresponding to the passenger indicated by the instruction passenger name, as the control target content.

According to the content control device of Configuration 9, when it is determined that the priority passenger information matches the instruction passenger name and the priority passenger information is the second passenger information, the content control unit inquires of the passenger whether to determine the content to be output by the account information corresponding to the passenger indicated by the instruction passenger name, as the control target content. Therefore, the control target content can be determined appropriately according to the response from the passenger.

### (Configuration 10)

In the content control device according to Configuration 9, when a response to the inquiry to the passenger indicates permission, the content to be output by the account information corresponding to the passenger indicated by the instruction passenger name is determined as the control target content.

According to the content control device of Configuration 10, when the response of the passenger to the inquiry to the passenger indicates permission, the content to be output by the account information corresponding to the passenger indicated by the instruction passenger name is determined as the control target content, and thus the control target content can be determined appropriately.

### (Configuration 11)

In the content control device according to any one of Configurations 5 to 8, when the content control unit determines that the priority passenger information matches the instruction passenger name and the priority passenger information is the first passenger information, and when the account information corresponding to the instruction passenger name does not match all of the account information in comparison with the account information corresponding to each of the plurality of contents output by the content output unit, the content control unit inquires of the passenger whether to switch the account information corresponding to the second passenger information to the account information corresponding to the instruction passenger name.

According to the content control device of Configuration 11, when it is determined that the priority passenger information matches the instruction passenger name and the priority passenger information is the first passenger information, and when the account information corresponding to the instruction passenger name does not match all of the account information in comparison with the account information corresponding to each of the plurality of contents output by the content output unit, the content control unit inquires of the passenger whether to switch the account information corresponding to the second passenger information to the account information corresponding to the instruction passenger name. Therefore, it is possible to appropriately determine whether to switch the account information corresponding to the second passenger information to the account information corresponding to the instruction passenger name.

### (Configuration 12)

In the content control device according to any one of Configurations 2 to 4, when each of the first passenger information and the second passenger information does not match the instruction passenger name, and when there is the content for which each of the first passenger information and the second passenger information is not set, out of the plurality of contents output by the content output unit, the content control unit determines the content for which each of the first passenger information and the second passenger information is not set, as the control target content.

According to the content control device of Configuration 12, when each of the first passenger information and the second passenger information does not match the instruction passenger name, and when there is the content for which each of the first passenger information and the second passenger information is not set, out of the plurality of contents output by the content output unit, the content for which each of the first passenger information and the second passenger information is not set, is determined as the control target content. Therefore, the control target content can be determined appropriately.

### (Configuration 13)

In the content control device according to any one of Configurations 2 to 4, when each of the first passenger information and the second passenger information does not match the instruction passenger name, and when there are a plurality of contents for which each of the first passenger information and the second passenger information is not set, out of the plurality of contents output by the content output unit, the content control unit inquires of the passenger which content, among the plurality of contents, is determined to be the control target content.

According to the content control device of Configuration 13, when each of the first passenger information and the second passenger information does not match the instruction passenger name, and when there are a plurality of contents for which each of the first passenger information and the second passenger information is not set, out of the plurality of contents output by the content output unit, the content control unit inquires of the passenger which content, among the plurality of contents, is determined to be the control target content. Therefore, the control target content can be determined appropriately according to the response from the passenger.

### (Configuration 14)

A content control method performed by a content control device, the content control device including: a content output unit that outputs a content to each of a plurality of seats arranged in a vehicle; a voice detection unit that detects a speaking content of a passenger in the vehicle; a content control unit that controls the content output unit based on the speaking content detected by the voice detection unit; and a passenger detection unit that detects a passenger seated on each of the plurality of seats, in which, when the speaking content involves an instruction passenger name indicating a passenger seated on a seat to whom a change in the content is to be instructed, the content control unit executes a determining step of determining a control target content, which is a content to be controlled based on the speaking content, based on the instruction passenger name, first passenger information detected by the passenger detection unit and indicating the passenger seated on the seat corresponding to each of the plurality of contents output by the content output unit, and account information corresponding to each of the plurality of contents output by the content output unit.

The content control method of Configuration 14 has the same configuration as the content control device of Configuration 1, and thus has the same operational effects as the content control device of Configuration 1.

### (Configuration 15)

A non-transitory computer readable storage medium storing a content control program that causes a processor included in a content control device to function as: a content output unit that outputs a content to each of a plurality of seats arranged in a vehicle; a voice detection unit that detects a speaking content of a passenger in the vehicle; a content control unit that controls the content output unit based on the speaking content detected by the voice detection unit; and a passenger detection unit that detects a passenger seated on each of the plurality of seats, in which, when the speaking content involves an instruction passenger name indicating a passenger seated on a seat to whom a change in the content is to be instructed, the content control unit determines a control target content, which is a content to be controlled based on the speaking content, based on the instruction passenger name, first passenger information detected by the passenger detection unit and indicating the passenger seated on the seat corresponding to each of the plurality of contents output by the content output unit, and account information corresponding to each of the plurality of contents output by the content output unit.

The storage medium of Configuration 15 has the same configuration as the content control device of Configuration 1, and thus has the same operational effects as the content control device of Configuration 1.

### REFERENCE SIGNS LIST

100 vehicle, 1 seat, 11 first seat, 12 second seat, 13 third seat, 14 fourth seat, 15 fifth seat, 2 content control device, 21 processor, 211 content output unit, 212 account acquisition unit, 213 passenger detection unit, 214 voice detection unit, 215 content control unit, 22 memory, 221 account storage unit, 222 association storage unit, 223 second passenger information storage unit, 224 first passenger information storage unit, 225 instruction name storage unit, 23 communication interface, 3 input/output mechanism, 31 first input/output mechanism, 311 first touch panel, 312 first speaker, 313 first microphone, 33 third input/output mechanism, 331 third touch panel, 332 third speak, 333 third microphone, 35 fifth input/output mechanism, 351 fifth touch panel, 352 fifth speaker, 353 fifth microphone, 4 camera, 5 server device, 51 first server device, 52 second server device, 53 third server device, AT, AT1, AT3, AT5 account information, C, C1, C3, C5 content, CN instruction passenger name, CS instruction content name, CT control content, Cα control target content, Cβ content, DT1 first date-and-time information, DT2 second date-and-time information, MC microphone, P, PA, PB, PC passenger, PG control program (content control program), PJ passenger information, PJ1 first passenger information, PJ2 second passenger information, PJA priority passenger information, PT image, SP speaker, TP touch panel.

1. A content control device comprising:
a content output unit that outputs a content to each of a plurality of seats arranged in a vehicle;
a voice detection unit that detects a speaking content of a passenger in the vehicle;
a content control unit that controls the content output unit based on the speaking content detected by the voice detection unit; and
a passenger detection unit that detects a passenger seated on each of the plurality of seats, wherein
when the speaking content involves an instruction passenger name indicating a target passenger to whom a change in the content is to be instructed,
the content control unit determines a control target content, which is a content to be controlled based on the speaking content, based on the instruction passenger name, first passenger information detected by the passenger detection unit and indicating the passenger seated on the seat corresponding to each of the plurality of contents output by the content output unit, and account information corresponding to each of the plurality of contents output by the content output unit.

2. The content control device according to claim 1,
the content control unit determines the control target content based on the instruction passenger name, the first passenger information, and second passenger information indicating a passenger corresponding to the account information.

3. The content control device according to claim 2, wherein
when the first passenger information and the second passenger information match the instruction passenger name,
the content control unit determines, from the plurality of contents output by the content output unit, a content to be output to a seat on which a passenger indicated by the instruction passenger name is seated, as the control target content.

4. The content control device according to claim 2, wherein
when the first passenger information matches the instruction passenger name and the second passenger information is not detected,
the content control unit determines, from the plurality of contents output by the content output unit, the content to be output to the seat on which the passenger indicated by the instruction passenger name is seated, as the control target content, and
when the first passenger information is not detected and the second passenger information matches the instruction passenger name,
the content control unit determines, from the plurality of contents output by the content output unit, the content to be output by the account information corresponding to the passenger indicated by the instruction passenger name, as the control target content.

5. The content control device according to claim 2, wherein
when one of the first passenger information and the second passenger information matches the instruction passenger name and the other of the first passenger information and the second passenger information does not match the instruction passenger name,
the content control unit selects, as priority passenger information, which of the first passenger information and the second passenger information has the most recent detected date and time, and determines whether the priority passenger information matches the instruction passenger name.

6. The content control device according to claim 5, wherein
when the content control unit determines that the priority passenger information does not match the instruction passenger name,
the content control unit does not determine the content to be output to the seat on which the passenger indicated by the instruction passenger name is seated, as the control target content.

7. The content control device according to claim 5, wherein
when the content control unit determines that the priority passenger information matches the instruction passenger name and the priority passenger information is the first passenger information,
the content control unit determines the content to be output to the seat, on which the passenger indicated by the instruction passenger name is seated, as the control target content.

8. The content control device according to claim 5, wherein
when the content control unit determines that the priority passenger information matches the instruction passenger name and the priority passenger information is the first passenger information,
the content control unit switches the account information corresponding to the second passenger information to account information corresponding to the instruction passenger name.

9. The content control device according to claim 5, wherein
when the content control unit determines that the priority passenger information matches the instruction passenger name and the priority passenger information is the second passenger information,
the content control unit inquires of the passenger whether to determine the content to be output by the account information corresponding to the passenger indicated by the instruction passenger name, as the control target content.

10. The content control device according to claim 9, wherein
when a response to the inquiry to the passenger indicates permission,
the content to be output by the account information corresponding to the passenger indicated by the instruction passenger name is determined as the control target content.

11. The content control device according to claim 5, wherein
when the content control unit determines that the priority passenger information matches the instruction passenger name and the priority passenger information is the first passenger information, and
when the account information corresponding to the instruction passenger name does not match all of the account information in comparison with the account information corresponding to each of the plurality of contents output by the content output unit,
the content control unit inquires of the passenger whether to switch the account information corresponding to the second passenger information to the account information corresponding to the instruction passenger name.

12. The content control device according to claim 2, wherein
when each of the first passenger information and the second passenger information does not match the instruction passenger name, and
when there is a content for which each of the first passenger information and the second passenger information is not set, out of the plurality of contents output by the content output unit,
the content control unit determines the content for which each of the first passenger information and the second passenger information is not set, as the control target content.

13. The content control device according to claim 2, wherein
when each of the first passenger information and the second passenger information does not match the instruction passenger name, and
when there are a plurality of contents for which each of the first passenger information and the second passenger information is not set, out of the plurality of contents output by the content output unit,
the content control unit inquires of the passenger which content, among the plurality of contents, is determined to be the control target content.

14. A content control method performed by a content control device,
the content control device including:
a content output unit that outputs a content to each of a plurality of seats arranged in a vehicle;
a voice detection unit that detects a speaking content of a passenger in the vehicle;
a content control unit that controls the content output unit based on the speaking content detected by the voice detection unit; and
a passenger detection unit that detects a passenger seated on each of the plurality of seats, wherein
when the speaking content involves an instruction passenger name indicating a passenger seated on a seat to whom a change in the content is to be instructed,
the content control unit executes a determining step of determining a control target content, which is a content to be controlled based on the speaking content, based on the instruction passenger name, first passenger information detected by the passenger detection unit and indicating the passenger seated on the seat corresponding to each of the plurality of contents output by the content output unit, and account information corresponding to each of the plurality of contents output by the content output unit.

15. A non-transitory computer readable storage medium storing a content control program that causes a processor included in a content control device to function as:
a content output unit that outputs a content to each of a plurality of seats arranged in a vehicle;
a voice detection unit that detects a speaking content of a passenger in the vehicle;
a content control unit that controls the content output unit based on the speaking content detected by the voice detection unit; and
a passenger detection unit that detects a passenger seated on each of the plurality of seats, wherein
when the speaking content involves an instruction passenger name indicating a passenger seated on a seat to whom a change in the content is to be instructed,
the content control unit determines a control target content, which is a content to be controlled based on the speaking content, based on the instruction passenger name, first passenger information detected by the passenger detection unit and indicating the passenger seated on the seat corresponding to each of the plurality of contents output by the content output unit, and account information corresponding to each of the plurality of contents output by the content output unit.
